(19) United States
(12) Patent Application Publication
(10) Pub. No.: US 2014/0335309 A1
(43) Pub. Date: Nov. 13, 2014

(54) LIGHT DIRECTING FILMS AND METHODS OF MAKING SAME

(71) Applicant: 3M INNOVATIVE PROPERTIES COMPANY, St. Paul, MN (US)

(72) Inventors: Robert M. Emmons, St. Paul, MN (US); Bryan V. Hung, Nowthen, MN (US); Corey D. Balts, Eau Claire, WI (US)

(21) Appl. No.: 14/356,645

(22) PCT Filed: Jan. 25, 2013
(86) PCT No.: PCT/US2013/023150

§ 371 Date: May 7, 2014

Related U.S. Application Data
(60) Provisional application No. 61/593,071, filed on Jan. 31, 2012.
(60) Provisional application No. 61/593,725, filed on Feb. 1, 2012.

(51) Int. Cl. G02B 5/04

(52) U.S. Cl. CPC G02B 5/045
USPC 428/141

(57) ABSTRACT

Light directing films have a surface comprising a plurality of microstructures with peaks extending along a length of the surface. Each microstructure includes a plurality of elevated portions and a plurality of non-elevated portions. A void diameter, D?c#191, of the largest circle that can be overlaid on the surface of the light directing film without including at least a portion of an elevated portion is less than about 0.5 mm. The light directing film cannot be divided into a plurality of same size and shape grid cells forming a continuous two-dimensional grid, where each of at least 90% of the grid cells comprise either a single leading edge of an elevated portion, or a portion of an elevated portion where the elevated portion has a length that is greater than the average length of the elevated portions.

### FIELD OF THE INVENTION

This disclosure generally relates to light directing films, methods of making such light directing films, and displays incorporating such films.

### BACKGROUND

Flat panel displays, such as displays that include a liquid crystal display (LCD) panel, often incorporate one or more light directing films to enhance display brightness along a pre-determined viewing direction. Such light directing films typically include a plurality of linear microstructures that direct the light toward the viewing direction. When placed in a stack, light directing films can optically couple to one another, producing undesirable visual defects denoted “wet-out.”

### SUMMARY OF THE INVENTION

Embodiments disclosed herein involve light directing films. According to some embodiments, a light directing film includes a surface comprising a plurality of microstructures with peaks extending along a length of the surface. Each microstructure includes a plurality of elevated portions and a plurality of non-elevated portions, wherein a diameter, D_{c}, of a largest circle that can be overlaid on the surface without including at least a portion of an elevated portion is less than about 0.5 mm, and wherein the light directing film cannot be divided into a plurality of same size and shape grid cells forming a continuous two-dimensional grid, where each of at least 90% of the grid cells comprise either a single leading edge of an elevated portion, or a portion of an elevated portion where the elevated portion has a length that is greater than the average length of the elevated portions.

According to some aspects, the number density of elevated portions in the arrangement, N_{DEP}, is less than about 2500/cm² or even less than about 1223/cm². In some cases, D_{c} is less than about 0.40 mm or less than about 0.30 mm, or less than about 0.25 mm. The pitch of the microstructures can be between about 5 microns to about 200 microns and an average length of the elevated portions may be between about 0.15 and 0.6 mm, for example.

Some embodiments involve a light directing film that has a surface comprising a plurality of microstructures having peaks extending along a length of the surface. The surface includes an arrangement of elevated portions disposed in an irregular pattern on the peaks. A void diameter, D_{c}, of a largest circle that can be overlaid on the surface of the light directing film without including at least a portion of an elevated portion is less than about

$$0.6125 \sqrt{\frac{2447}{{N}_{DEP}}} {e}^{- 0.7159 L} ,$$

where N_{DEP} is a number density of the elevated portions/cm², and L is an average length of the elevated portions in millimeters. In some implementations, the light directing film cannot be divided into a plurality of same size and shape grid cells forming a continuous two-dimensional grid, where each of at least 90% of the grid cells comprise either a single leading edge of an elevated portion, or a portion of an elevated portion where the elevated portion has a length that is greater than the average length of the elevated portions.

Some embodiments involve a light directing film with a surface comprising a plurality of microstructures having peaks extending along a length of the surface. The surface includes an arrangement of elevated portions and non-elevated portions disposed in an irregular pattern on the peaks. The elevated portions have an average length, L and a number density N_{DEP}. The void diameter, D_{c}, of the light directing film is the diameter of the largest circle that can be overlaid on the surface of the light directing film without including at least a portion of an elevated portion. The light directing film has at least one of:

$$L \leq about 0.57 mm and {D}_{c} \leq [ \begin{matrix}about 0.577 mm , for {N}_{DEP} \leq about 1224 / {cm}^{2} \\ about 0.408 mm , for {N}_{DEP} \leq about 2448 / {cm}^{2} \\ about 0.289 mm , for {N}_{DEP} \leq about 4894 / {cm}^{2}\end{matrix} , \\ L \leq about 0.28 mm and {D}_{c} \leq [ \begin{matrix}about 0.707 mm , for {N}_{DEP} \leq about 1224 / {cm}^{2} \\ about 0.5 mm , for {N}_{DEP} \leq about 2448 / {cm}^{2} \\ about 0.354 mm , for {N}_{DEP} \leq about 4894 / {cm}^{2}\end{matrix} , \\ and \\ L \leq about 0.14 mm and {D}_{c} \leq [ \begin{matrix}about 0.783 mm , for {N}_{DEP} \leq about 1224 / {cm}^{2} \\ about 0.553 mm , for {N}_{DEP} \leq about 2448 / {cm}^{2} \\ about 0.391 mm , for {N}_{DEP} \leq about 4894 / {cm}^{2}\end{matrix} .$$

In some implementations, values for D₀, N_{DEP}, L and D_{c} can satisfy Table 32.

Some embodiments involve a light directing film wherein the light directing film has at least one of:

$$L \leq about 0.57 mm and {D}_{c} \leq [ \begin{matrix}about 0.387 mm , for {N}_{DEP} \leq about 1224 / {cm}^{2} \\ about 0.274 mm , for {N}_{DEP} \leq about 2448 / {cm}^{2} \\ about 0.193 mm , for {N}_{DEP} \leq about 4894 / {cm}^{2}\end{matrix} , \\ L \leq about 0.28 mm and {D}_{c} \leq [ \begin{matrix}about 0.475 mm , for {N}_{DEP} \leq about 1224 / {cm}^{2} \\ about 0.335 mm , for {N}_{DEP} \leq about 2448 / {cm}^{2} \\ about 0.237 mm , for {N}_{DEP} \leq about 4894 / {cm}^{2}\end{matrix} , \\ and \\ L \leq about 0.14 mm and {D}_{c} \leq [ \begin{matrix}about 0.525 mm , for {N}_{DEP} \leq about 1224 / {cm}^{2} \\ about 0.371 mm , for {N}_{DEP} \leq about 2448 / {cm}^{2} \\ about 0.262 mm , for {N}_{DEP} \leq about 4894 / {cm}^{2}\end{matrix} . \\ In some cases , the light directing film has at least one of \text{:} \\ L \leq about 0.57 mm and {D}_{c} \leq [ \begin{matrix}about 0.346 mm , for {N}_{DEP} \leq about 1224 / {cm}^{2} \\ about 0.244 mm , for {N}_{DEP} \leq about 2448 / {cm}^{2} \\ about 0.173 mm , for {N}_{DEP} \leq about 4894 / {cm}^{2}\end{matrix} , \\ L \leq about 0.28 mm and {D}_{c} \leq [ \begin{matrix}about 0.424 mm , for {N}_{DEP} \leq about 1224 / {cm}^{2} \\ about 0.300 mm , for {N}_{DEP} \leq about 2448 / {cm}^{2} \\ about 0.212 mm , for {N}_{DEP} \leq about 4894 / {cm}^{2}\end{matrix} , \\ and \\ L \leq about 0.14 mm and {D}_{c} \leq [ \begin{matrix}about 0.469 mm , for {N}_{DEP} \leq about 1224 / {cm}^{2} \\ about 0.332 mm , for {N}_{DEP} \leq about 2448 / {cm}^{2} \\ about 0.234 mm , for {N}_{DEP} \leq about 4894 / {cm}^{2}\end{matrix} . \\ In some cases , the light directing film has at least one of \text{:} \\ L \leq about 0.57 mm and {D}_{c} \leq [ \begin{matrix}about 0.288 mm , for {N}_{DEP} \leq about 1224 / {cm}^{2} \\ about 0.204 mm , for {N}_{DEP} \leq about 2448 / {cm}^{2} \\ about 0.144 mm , for {N}_{DEP} \leq about 4894 / {cm}^{2}\end{matrix} , \\ L \leq about 0.28 mm and {D}_{c} \leq [ \begin{matrix}about 0.353 mm , for {N}_{DEP} \leq about 1224 / {cm}^{2} \\ about 0.250 mm , for {N}_{DEP} \leq about 2448 / {cm}^{2} \\ about 0.176 mm , for {N}_{DEP} \leq about 4894 / {cm}^{2}\end{matrix} , \\ and L \leq about 0.14 mm and {D}_{c} \leq [ \begin{matrix}about 0.391 mm , for {N}_{DEP} \leq about 1224 / {cm}^{2} \\ about 0.276 mm , for {N}_{DEP} \leq about 2448 / {cm}^{2} . \\ about 0.195 mm , for {N}_{DEP} \leq about 4894 / {cm}^{2}\end{matrix}$$

According to some aspects, the microstructures may be linear prisms, e.g., linear prisms having an included angle of about 80 degrees to about 110 degrees. The microstructures may have any pitch, for example, the pitch may be between and about 5 microns to about 200 microns. In some cases the lateral cross sectional area of a microstructure of the plurality of microstructures in a region of an elevated portion and a lateral cross sectional area of the microstructure in a region of a non-elevated portion have the same shape. The heights of the elevated portions may vary or the heights of the elevated portions may be constant.

In some embodiments, a light directing film has a surface with a plurality of microstructures with peaks extending along a length of the surface. The surface includes an arrangement of elevated portions disposed on the peaks, wherein the arrangement of elevated portions is based on a quasi-random pattern. For example, the quasi-random pattern may comprise one or more of a Sobel pattern, a Halton pattern, a reverse Halton pattern, and a Neiderreiter pattern.

Some embodiments involve a method of making a light directing film having a plurality of microstructures with peaks extending along a surface of the light directing film. An arrangement for elevated portions disposed on the microstructures including obtaining two dimensional coordinates for the elevated portions in the arrangement is determined using a quasi-random number generator. The microstructures are formed with the elevated portions according to the arrangement.

In some cases, determining the arrangement includes modifying the coordinates determined using the quasi-random number generator to adjusted coordinates corresponding to locations on the peaks of the microstructures.

In some cases, the two dimensional coordinates for the elevated portions are determined using a Sobel, Halton, reverse Halton, and/or Neiderreiter algorithm.

According to some methods, an arrangement for disposing elevated portions on the peaks of the microstructures is determined by obtaining one or more two dimensional coordinates and comparing the coordinates with a criterion for placing the elevated portions. For example, the criterion may comprise a requirement for a minimum distance between the elevated portions. Coordinates that meet the criterion are selected and coordinates that do not meet the criterion are rejected. The positions of the elevated portions in the arrangement are determined using the selected coordinates. The microstructures with the elevated portions are formed according to the arrangement.

In some cases, the criterion takes into account anisotropy in the shape of the elevated portions. According to various aspects, the minimum distance may be about 1.3 mm or about 1.9 mm, for example.

According to some implementations, K coordinates are obtained, where K is greater than or equal to two. In some cases, if all the K coordinates are rejected for failure to meet the criterion, a coordinate of the K coordinates is selected that is a farthest distance from the elevated portions. In some cases, a coordinate of the K coordinates is selected that has a greater minimum distance than others of the K coordinates.

Some methods of determining an arrangement for disposing elevated portions on the peaks involves determining an initial arrangement using a first placement process to determine locations of a first fraction of the elevated portions and determining a final arrangement using a second placement process, different from the first placement process, to determine locations of a second fraction of the elevated portions. The microstructures are formed with the elevated portions positioned according to the final arrangement. The final arrangement can be determined by identifying voids that exceed a maximum void diameter criterion in the initial arrangement and placing the second fraction of the elevated portions at coordinates within the identified voids.

In some cases, determining the initial arrangement involves obtaining a plurality of two dimensional coordinates for the elevated portions, comparing coordinates of the plurality of coordinates with a minimum distance criterion between elevated portions, and using coordinates of the plurality of coordinates that meet the criterion in the arrangement and rejecting coordinates of the plurality of co that fail to meet the criterion. Determining the final arrangement involves identifying voids that exceed a maximum void diameter criterion in the initial arrangement, and identifying positions for the second fraction of elevated portions at coordinates within the identified voids.

Some embodiment are directed to a light directing film that includes a surface comprising a plurality of microstructures having peaks extending along a length of the surface of the light directing film. The surface comprises an arrangement of elevated portions and non-elevated portions disposed in an irregular pattern on the peaks. A void diameter, D_{c}, of a largest circle that can be overlaid on the surface of the light directing film without including at least a portion of an elevated portion is less than about

$$1.225 \sqrt{\frac{2447}{{N}_{DEP}}} {e}^{- 0.7159 L} {D}_{0} ,$$

for D₀ between about 0.250 and 0.336 mm, where N_{DEP} is a number density of the elevated portions/cm², and L is an average length of the elevated portions in millimeters. In various implementations values for D₀, N_{DEP}, L and D_{c} can satisfy one or more of Tables 33-35.

### BRIEF DESCRIPTION OF DRAWINGS

The embodiments presented may be more completely understood and appreciated in consideration of the following detailed description in connection with the accompanying drawings, in which:

FIGS. 1 and 2 are schematic three-dimensional and top views of a light directing film 100, respectively, which can include a feature arrangement according to embodiments described herein;

FIG. 3 is a schematic three-dimensional view of a linear microstructure that has a curvilinear cross-sectional profile and extends along a first direction;

FIGS. 4 and 5 are schematic side-views of microstructures of light directing film;

FIG. 6 is a schematic three-dimensional view of linear microstructures that extend along a first direction;

FIG. 7 is a cross-sectional view of a microstructure where a lateral cross-section in non-elevated region has the same shape as a lateral cross-section in elevated region;

FIG. 8 is a schematic three dimensional view of a cylindrical microreplication tool;

FIG. 9 shows a two dimensional (2D) design space that can be mapped to a portion of the surface of the microreplication tool of FIG. 8;

FIG. 10A shows an example of “bump feature” formed in the surface of a microreplication tool;

FIG. 10B shows the complementary bump feature on prism surface in the final light directing film produced from the tool of FIG. 10A.

FIGS. 11A and 11B show low resolution and high resolution images, respectively, of feature arrangements designed using a linear design method;

FIGS. 12A and 12B show low resolution and high resolution images, respectively, of feature arrangements designed using a random placement design method;

FIGS. 13A and 13B show low resolution and high resolution images, respectively, of feature arrangements designed using a grid-based design method;

FIGS. 14A and 14B show low resolution and high resolution images, respectively, of feature arrangements designed using a design method based on the Halton algorithm;

FIGS. 15A and 15B show low resolution and high resolution images, respectively, of feature arrangements designed using a design method based on the Reverse Halton algorithm;

FIGS. 16A and 16B show low resolution and high resolution images, respectively, of feature arrangements designed using a design method based on the Sobel algorithm;

FIGS. 17A and 17B show low resolution and high resolution images, respectively, of feature arrangements designed using a design method based on the Neiderreiter algorithm;

FIG. 18 illustrates a constrained placement design method;

FIGS. 19A and 19B show low and high resolution images, respectively, of feature arrangements designed using a constrained placement method having a minimum separation factor, F=0.4;

FIGS. 20A and 20B show low and high resolution images, respectively, of a feature arrangement designed using a Best of K method, K=10;

FIGS. 21A and 21B show low and high resolution images, respectively, of a feature arrangement designed using a hybrid method that includes random placement of a first set of features and constrained spacing placement for the remaining features;

FIGS. 22A and 22B show low and high resolution images, respectively, of a feature arrangement designed using a constrained placement and Best of K hybrid methodology with a constrained scaling factor F=0.6, and with K=200;

FIGS. 23 and 24 are plots that show the cumulative frequency of all voids by diameter starting with the largest voids for various design techniques;

FIGS. 25 and 26 plot cumulative fractional area versus distance to the nearest feature for various design techniques;

FIG. 27 shows the 20 largest voids found in a 3 inch by 3 inch region having a feature arrangement designed using the linear design method;

FIG. 28 shows the 20 largest voids found in a 3 inch by 3 inch region having a feature arrangement designed using the constrained spacing, F=0.6+Best of K, for K=200 method;

FIG. 29 illustrates the result of using the retrospective void-filling process for an initial design of constrained placement with an F value of 0.6 in conjunction with an limit of K=200 with voids greater than 0.25 mm retrospectively filled with an additional feature;

FIG. 30 shows the dependence of relative maximum void size versus relative feature length using a random layout method and our standard base-case as the center point;

FIG. 31 shows void size scaled to other number densities based on a diameter of 0.5 mm, at 2447/cm² feature density; and

FIGS. 32-35 are tables that show void sizes for various feature densities and lengths based on reference void sizes.

In the specification, a same reference numeral used in multiple figures refers to the same or similar elements having the same or similar properties and functionalities.

### DETAILED DESCRIPTION

The embodiments described herein generally relate to light directing films that have a substantially uniform appearance when incorporated into a display such as a liquid crystal display. Some approaches to reduce wet-out defects in light directing films include the use of elevated portions or bumps disposed along the peaks of the films' light directing microstructures. The elevated portions limit optical coupling between a light directing film and a neighboring film or layer primarily to the elevated portions. The elevated portions are distributed across the light directing film in a manner that results in the light directing film, and a display that incorporates the light directing film, having a uniform appearance.

Approaches described herein involve light directing films with a structured surface that includes a plurality of microstructures. The microstructures have peaks extending along a length of the surface of the light directing film with an irregular arrangement of elevated portions or “bumps” and disposed on the peaks. Voids exist between the elevated portions. The size of the voids in an arrangement of elevated portions of a light directing film can be characterized by D_{c}, which is the largest circle that can be overlaid on the surface of the light directing film without including at least a portion of an elevated portion. According to various embodiments discussed herein, the voids in the arrangement may have D_{c} less than or equal to about 0.5 mm and a number density of elevated portions in the arrangement, N_{DEP}, that is less than about 2500/cm² or even less than about 1223/cm². In some implementations, the void size, D_{c}, can be less than 0.40 mm, 0.30 mm or even less than 0.25 mm.

According to some approaches, the light directing film cannot be divided into a plurality of same size and shape grid cells forming a hypothetical continuous two-dimensional grid, where each of at least 90% of the grid cells comprise either a single leading edge of an elevated portion, or a portion of an elevated portion where the elevated portion has a length that is greater than the average length of the elevated portions. In some embodiments, the light directing film cannot be divided into a plurality of same size and shape grid cells forming a continuous two-dimensional grid, where each of at least 80%, 70%, 60%, or even 50% of the grid cells comprise either a single leading edge of an elevated portion, or a portion of an elevated portion where the elevated portion has a length that is greater than the average length of the elevated portions.

The maximum void diameter and feature density constraints discussed above can be achieved using one or more of a variety of design methods that determine an arrangement of elevated portions (also referred to herein as “bump features,” “features”, or “bumps”) on a two dimensional design space. For example, the design of the film may be based on random, pseudorandom and/or quasi-random algorithms that are used for placement of the features. In some cases, these algorithms are used in conjunction with additional design constraints that produce a film design that achieves the void diameter and feature number density constraints expressed above.

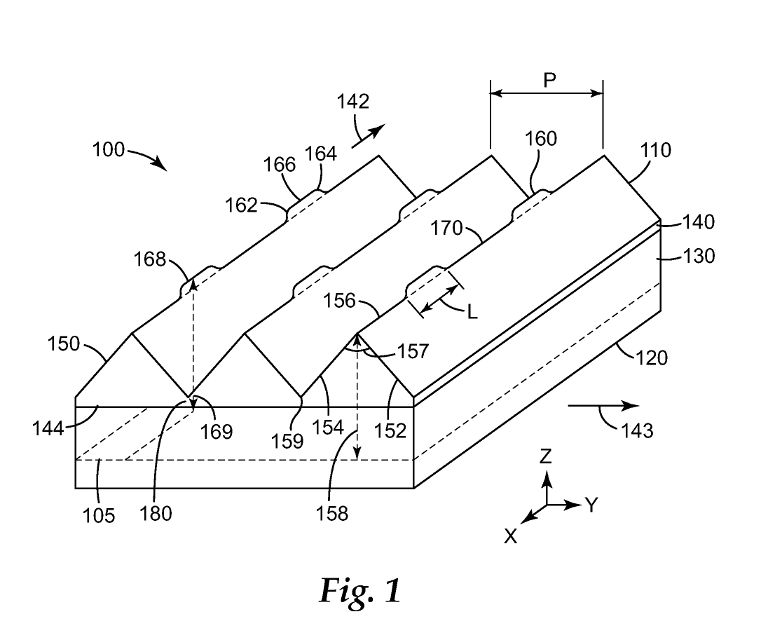

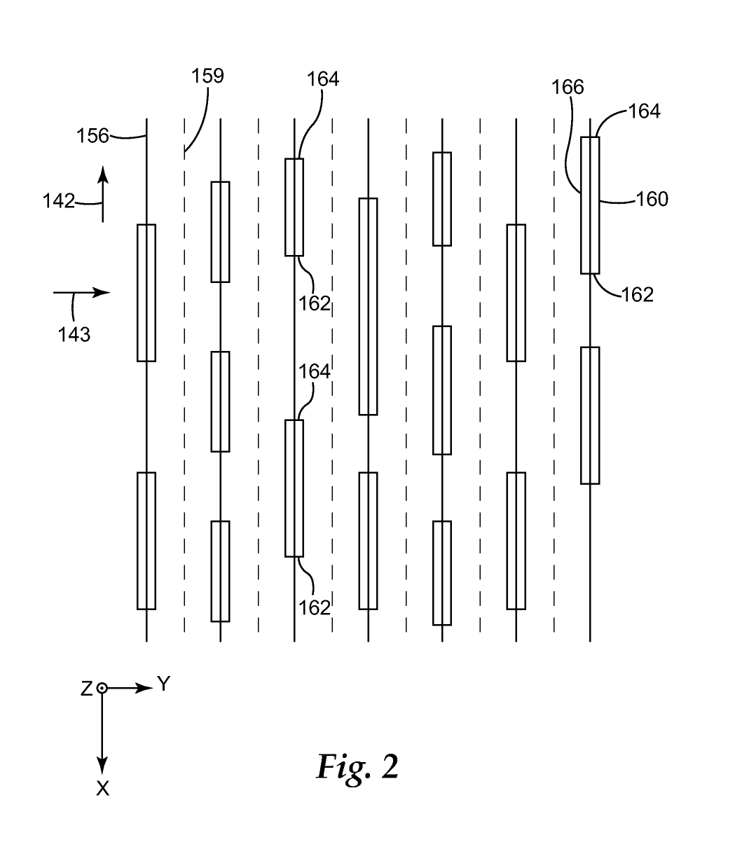

FIGS. 1 and 2 are schematic three-dimensional and top views of a light directing film 100, respectively. The light directing film 100 generally lies in the xy-plane and includes a first structured major surface 110 and an opposing second major surface 120. First structured major surface 110 includes a plurality of microstructures 150 that extend along a first direction 142 that, in the exemplary light directing film 100, is parallel to the x-axis. Light directing film 100 includes a structured layer 140 disposed on a substrate 130, where structured layer 140 includes first structured major surface 110 and substrate 130 includes second major surface 120. The exemplary light directing film 100 includes two layers. In general, light directing films that have feature arrangements as discussed herein can include one or more layers.

Each microstructure 150 includes a plurality of elevated portions 160 and a plurality of non-elevated portions 170. In general, each microstructure 150 includes alternating elevated and non-elevated portions. Elevated portions 160 substantially prevent optical coupling between non-elevated portions 170 and an adjacent layer that is placed on and comes into optical or physical contact with light directing film 100. Elevated portions 160 confine any optical coupling predominately to the elevated portions 160. Elevated portions 160 can be considered to be portions disposed on peaks 156 of microstructures 150.

In general, the density, such as the number, line, or area density of elevated portions 160 is sufficiently low so that optical coupling at the elevated portions does not significantly reduce the optical gain of the light directing film, and sufficiently high so as to confine optical coupling to the elevated portions or regions of the light directing film. In some cases, the density of elevated portions 160 along peak 156 of a microstructure 150 is not greater than about 30%, or not greater than about 25%, or not greater than about 20% of the length of the microstructure along the first direction 142. In some cases, the density of elevated portions 160 along peak 156 of a microstructure is not less than about 5%, or not less than about 10%, or not less than about 15%. In some cases, the number density of elevated portions 160 per unit area is not greater than about 10,000 per cm², or not greater than about 9,000 per cm², or not greater than about 8,000 per cm², or not greater than about 7,000 per cm², or not greater than about 6,000 per cm², or not greater than about 5,000 per cm², or not greater than about 4,500 per cm², or not greater than about 4,000 per cm², or not greater than about 3,500 per cm², or not greater than about 3,000 per cm², or not greater than about 2,500 per cm². In some cases, the number density of elevated portions 160 per unit area is not less than about 500 per cm², or not less than about 750 per cm², or not less than about 1,000 per cm², or not less than about 1,250 per cm², or not less than about 1,500 per cm², or not less than about 1,750 per cm², or not less than about 2,000 per cm². In some cases, the elevated portions of each microstructure cover at least about 1%, or at least 1.5%, or at least 3%, or at least 5%, or at least 7%, or at least 10%, or at least 13%, or at least 15%, of the microstructure along the first direction 142.

Each elevated portion 160 includes a length L along first direction 142 where, in general, different elevated portions can have different lengths. In general, elevated portions 160 have an average length that can be in a range from about 10 microns to about 500 microns, or from about 25 microns to about 450 microns, or from about 50 microns to about 450 microns, or from about 50 microns to about 400 microns, or from about 75 microns to about 400 microns, or from about 75 microns to about 350 microns, or from about 100 microns to about 300 microns.

Each elevated portion 160 includes a leading edge 162 along first direction 142, a trailing edge 164 along the first direction, and a main portion 166 between and connecting the leading edge and the trailing edge. Leading edges 162 are on the same side or end of the elevated portions and trailing edges 164 are on the opposite side or end of the elevated portions. Stated in a different way, when travelling along the peak of a microstructure, the leading edge of an elevated portion is encountered first, then the main portion of the elevated portion, followed by the trailing edge of the elevated portion.

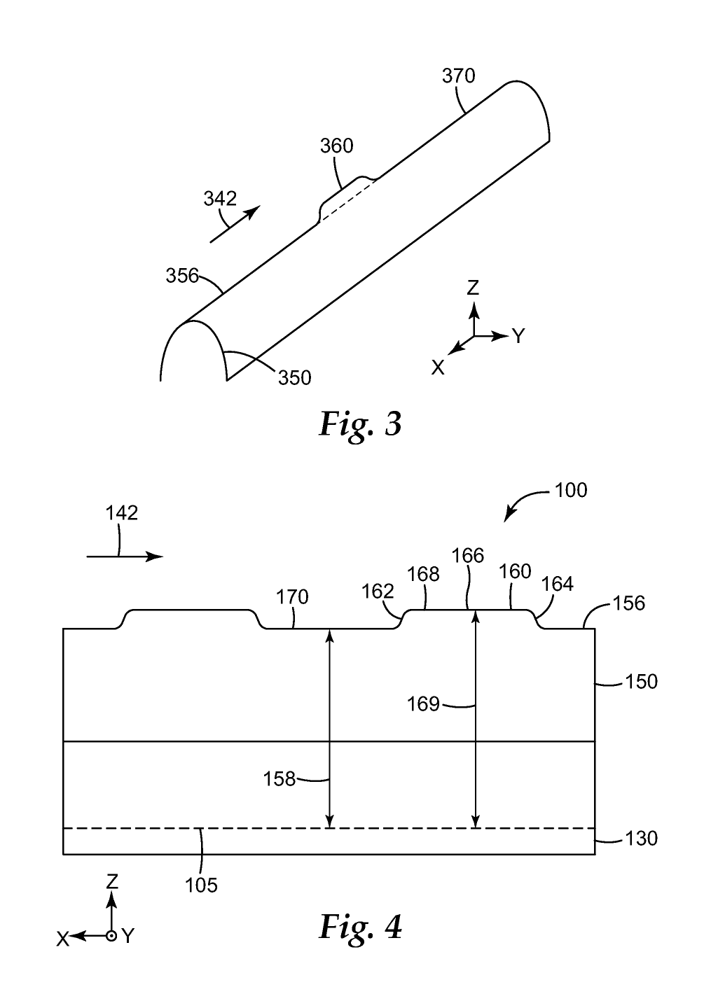

Referring to FIG. 1, the exemplary microstructures 150 have prismatic cross-sectional profiles. Each microstructure 150 includes a first side 152 and a second side 154 that meet at peak 156, a peak or apex angle 157, and a peak height 158 as measured from the peak to a common reference plane 105 disposed between first structured major surface 110 and second major surface 120. In general, microstructures 150 can have any shape that is capable of directing light and, in some cases, providing optical gain. For example, in some cases, microstructures 150 can have curvilinear cross-sectional profiles, or rectilinear cross-sectional profiles. For example, FIG. 3 is a schematic three-dimensional view of a linear microstructure 350 that has a curvilinear cross-sectional profile and extends along a first direction 342. Microstructure 350 includes a peak 356, an elevated portion 360 disposed on peak 356, and a non-elevated portion 370.

Referring back to FIG. 1, elevated portions 160 of microstructures 150 have peaks 168 and peak heights 169, and non-elevated portions 170 of microstructures 150 have peaks 156 and peak heights 158, where peak heights are measured from the peaks to common reference plane 105 disposed between first structured major surface 110 and second major surface 120. As an example, the common reference plane can be second major surface 120 or a bottom major surface 144 of structured layer 140. In general, a non-elevated portion 170 can have a constant or varying peak height 158 along first direction 142. For example, in some cases, each non-elevated portion 170 has a constant peak height along the first direction. As another example, in some cases, non-elevated portions 170 of each microstructure 150 have the same constant peak height along the first direction.

For example, FIG. 4 is a schematic side-view of a microstructure 150 of light directing film 100, where non-elevated portions 170 of the microstructure have the same peak height 158 along first direction 142. As yet another example, in some cases, non-elevated portions 170 of the microstructures in the plurality of microstructures 150 have the same constant peak height along the first direction.

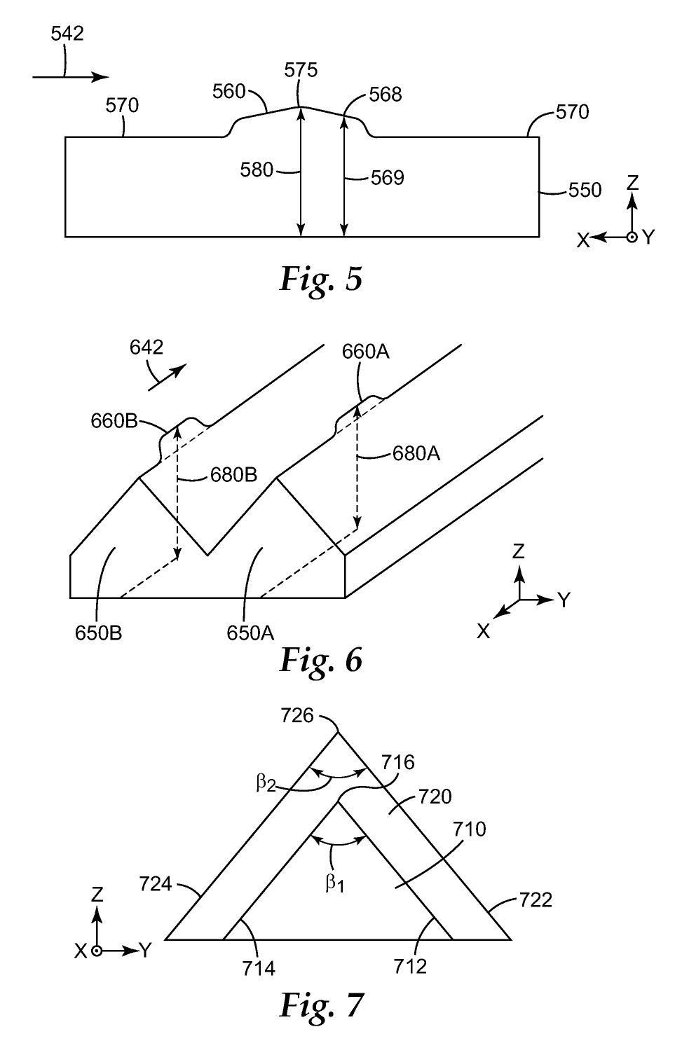

In general, an elevated portion 160 has a peak 168, a peak height 169, a maximum peak, and a maximum peak height. For example, FIG. 5 is a schematic side-view of a microstructure 550 that is similar to microstructures 150, extends along a first direction 542, and includes an elevated portion 560 and non-elevated portions 570. Elevated portion 560 includes a peak 568 and a peak height 569 that varies along the first direction and assumes a maximum peak height 580 at maximum peak 575. Referring back to FIG. 1, in general, elevated portions 160 of microstructures 150 may or may not have the same maximum peak height. In some cases, elevated portions 160 of the microstructures in the plurality of microstructures 150 have the same maximum peak height.

In some cases, a first elevated portion has a first maximum peak height and a second elevated portion has a second maximum peak height that is different than the first maximum peak height. For example, FIG. 6 is a schematic three-dimensional view of linear microstructures 650A and 650B that extend along a first direction 642. Microstructure 650A includes an elevated portion 660A that has a maximum peak height 680A and an elevated portion 660B that has a maximum peak height 680B, where maximum peak height 680B is greater than maximum peak height 680A.

Referring back to FIG. 1, structured layer 140 includes a land region 180 defined as the region between valleys 159 and bottom major surface 144 of structured layer 140. In some cases, the primary functions of the land region can include transmitting light with high efficiency, providing support for the microstructures, and providing sufficient adhesion between the microstructures and the substrate. In general, land region 180 can have any thickness that may be suitable in an application. In some cases, the thickness of land region 180 is less than about 20 microns, or less than about 15 microns, or less than about 10 microns, or less than about 8 microns, or less than about 6 microns, or less than about 5 microns. In general, structured layer 140 may or may not include a land region. In some cases, such as in the exemplary light directing film 100, structured layer 140 includes a land region. In some cases, structured layer 140 does not include a land region.

The exemplary light directing film 100 includes two layers: structured layer 140 disposed on substrate 130. In general, a disclosed light directing film can have one or more layers. For example, in some, cases, light directing film 100 can be a unitary construction and include a single layer.

In general, substrate 130 can be or include any material that may be desirable in an application. For example, substrate 130 can include or be made of glass and/or polymers such as polyethylene terapthalate (PET), polycarbonates, and acrylics. In some cases, the substrate can have multiple layers. In general, substrate 130 can provide any function that may be desirable in an application. For example, in some cases, substrate 130 may primarily provide support for the other layers. As another example, in some cases, a substrate 130 may polarize light by including, for example, a reflective or absorbing polarizer, or diffuse light by including an optical diffuser.

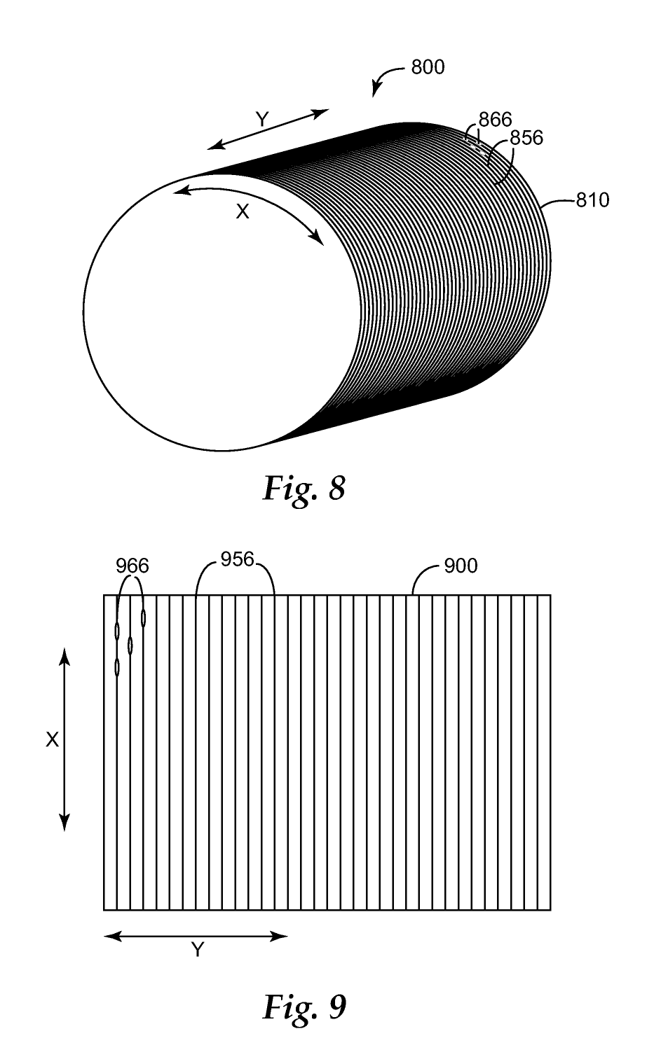

In some cases, a lateral cross-section of a disclosed microstructure in a region of an elevated portion and in a region of a non-elevated portion have the same shape as described in PCT Publication WO2009/124107 (Campbell et al.) which is incorporated herein in its entirety by reference. For example, FIG. 7 is a cross-sectional view of a microstructure similar to microstructures 150 where a lateral cross-section 710 (cross-section in the yz-plane or in a plane perpendicular to first direction 142) in non-elevated region 170 has the same shape as a lateral cross-section 720 in elevated region 160.

Cross-section 710 includes a first side 712 and a second side 714 that meet at a peak 716 and form a peak angle β₁. Cross-section 720 includes a first side 722 and a second side 724 that meet at a peak 726 and form a peak angle β₂, where β₂ is substantially equal to β₁, first side 722 is substantially parallel to first side 712, and second side 724 is substantially parallel to second side 714.

Referring back to FIG. 1, apex, peak, or dihedral angle 157 can have any value that may be desirable in an application. For example, in some cases, apex angle 157 can be in a range from about 70 degrees to about 110 degrees, or from about 80 degrees to about 100 degrees, or from about 85 degrees to about 95 degrees. In some cases, microstructures 150 have equal apex angles which can, for example, be in a range from about 88 or 89 degrees to about 92 or 91 degrees, such as 90 degrees. In general, apex or peak 156 can be sharp, rounded or flattened or truncated. For example, microstructures 150 can be rounded to a radius in a range of about 1 to 4 to 7 to 15 micrometers.

Structured layer 140 can have any index of refraction that may be desirable in an application. For example, in some cases, the index of refraction of the structured layer is in a range from about 1.4 to about 1.8, or from about 1.5 to about 1.8, or from about 1.5 to about 1.7. In some cases, the index of refraction of the structured layer is not less than about 1.5, or not less than about 1.54, or not less than about 1.55, or not less than about 1.56, or not less than about 1.57, or not less than about 1.58, or not less than about 1.59, or not less than about 1.6, or not less than about 1.61, or not less than about 1.62, or not less than about 1.63, or not less than about 1.64, or not less than about 1.65, or not less than about 1.66, or not less than about 1.67, or not less than about 1.68, or not less than about 1.69, or not less than about 1.7. In some cases, the refractive index of structured layer 140 is increased by including various brominated (meth)acrylate monomers, as described in the art. In some cases, structured layer 140 is non-brominated, meaning that the structured layer does not include bromine substituents. In such cases, however, a detectable amount, i.e. less than 1 wt-% (as measured according to Ion Chromatography) of bromine may be present as a contaminant. In some cases, the structured layer is non-halogenated. In such cases, however, a detectable amount, i.e. less than 1 wt-% (as measured according to Ion Chromatography) of halogen may be present as a contaminant.

In some cases, the refractive index of structured layer 140 is increased by including surface modified (e.g. colloidal) inorganic nanoparticles. In some cases, the total amount of surface modified inorganic nanoparticles present in structured layer 140 can be in an amount of at least 10 wt-%, or at least 20 wt-%, or at least 30 wt-%, or at least 40 wt-%. The nanoparticles can include metal oxides such as, for example, alumina, zirconia, titania, mixtures thereof, or mixed oxides thereof.

Microstructures 150 form a periodic pattern along a second direction 143 that is perpendicular to first direction 142. The periodic pattern has a pitch or period P defined as the distance between adjacent or neighboring microstructure peaks 156. In general, microstructures 150 can have any period that may be desirable in an application. In some cases, the period P is less than about 500 microns, or less than about 400 microns, or less than about 300 microns, or less than about 200 microns, or less than about 100 microns. In some cases, the pitch can be about 150 microns, or about 100 microns, or about 50 microns, or about 24 microns, or about 23 microns, or about 22 microns, or about 21 microns, or about 20 microns, or about 19 microns, or about 18 microns, or about 17 microns, or about 16 microns, or about 15 microns, or about 14 microns, or about 13 microns, or about 12 microns, or about 11 microns, or about 10 microns.

The light directing films disclosed herein have a substantially uniform appearance and when employed in a display, such as a liquid crystal display, and result in bright and substantially uniform displayed images. The light directing films disclosed herein, such as light directing film 100, can be fabricated by first fabricating a cutting tool, such as a diamond cutting tool. The cutting tool can then be used to create the desired microstructures in a microreplication tool. One embodiment of a microreplication tool 800 is illustrated in FIG. 8. The microreplication tool 800 can then be used to microreplicate the microstructures into a material or resin, such as a UV or thermally curable resin, resulting in a light directing film. The microreplication can be achieved by any suitable manufacturing method, such as UV cast and cure, extrusion, injection molding, embossing, or other known methods.

Cylindrical microreplication tool 800 that can be used to fabricate light directing films, such as film 100, for example, using a roll-to-roll process. The microreplication tool 800 includes a number of microstructures 856 comprising grooves which are complementary to prism peaks of the light directing film. For example, grooves 856 of microreplication tool 800 may be complementary to the prism peaks 156 of FIG. 1. The elevated portions 166 of the film 100 correspond to portions of the grooves 856 that have increased depth. Positions on the microreplication tool 800 are associated with x and y encoder outputs, where the x encoder output provides the position along the direction of the grooves 856 (the circumferential direction) and the y encoder output provides the position in the cross cut direction. When the microreplication tool 800 is formed, the increased depth portions 866 which corresponding to elevated portions 166 on the light directing film 100) can be cut into the microreplication tool at locations indicated by the x and y encoders used in forming the microreplication tool 800.

Microstructures can be cut into a microreplication tool by various methods. A microreplication tool might be flat, might be cylindrical (as shown in FIG. 8), or it might be flat tooling created by unrolling a cylindrical shell tool for example. In some examples, the microreplication tools are approximately 16″ in diameter, although any other useful diameter could be used with the methods discussed. Microreplication tools can be fabricated, for example, by plunge cutting or thread cutting patterns into the surface of the microreplication tool using a suitable device such as a lathe. In plunge cutting, the cutting tool is plunged into the microreplication tool at least once for each groove—and each groove closes onto itself. The microreplication tool is formed by creating multiple such grooves. In some implementations, a continuous groove is formed in the microreplication tool by thread cutting. In this process, the cutting tool is plunged into the microreplication tool surface once and a single groove is helically wrapped around the microreplication tool. Regardless of the method, the final microreplication tool is typically covered by one or a set of grooves with a characteristic pitch. Some examples in this discussion use a 24 micron thread pitch, but as previously discussed, the microstructures could have any convenient pitch. For example, pitches in the range of 5 microns to 200 microns are quite common in display applications.

The cutting tool used to create the grooves in the microreplication tool could be of any composition and shape that is suitable in application. For example, a diamond cutting tool is useful for this purpose. The profile on the cutting tools controls the groove shape. For purposes of this discussion, V-shaped cutting tools having a radius at the peak of less than 5 microns are used as an example. In various implementations, the profiles of the cutting tool (and the resultant microstructure profiles) can have an included angle of between 80 and 110 degrees, approximately straight edge segments, and a join section at the peak region with a radius less than 10 microns. These characteristics are often dependent on the design intent and the characteristic pitch used in cutting the microreplication tool. Other cutting tool profiles are of course possible including circular, elliptical, parabolic, or any other cutting tool profile that is robust enough to have a reasonable lifetime during cutting.

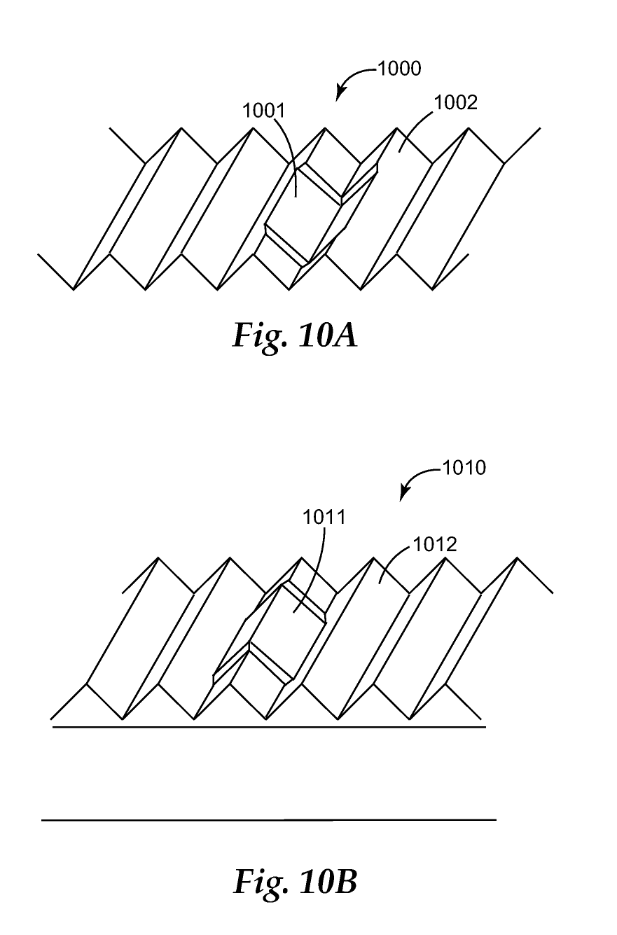

The elevated portions of the light directing films are formed by variation in the depth of the grooves of the microreplication tool. One method of varying the depth of the grooves (and hence the prism tip height in the final film), is to modulate the cutting depth using a servo that can be driven by some signal. For example, in some cases, signal is a rectangular wave type pattern typically with a nominal level and a “bump” level. FIG. 10A shows an example of “bump feature” 1001 formed in the surface 1002 of a microreplication tool 1000. FIG. 10B shows the complementary bump feature 1011 on prism surface 1012 in the final light directing film 1010 produced from a tool 1000. (The tool 1000 is the negative of the film 1010.) Embodiments described herein involve design implementations for designing an arrangement for these bump features so that they have good spacer properties and good visual appeal.

A two dimensional (2D) design space 900 shown in FIG. 9 can be mapped to a portion of the surface 810 of the microreplication tool 800. The grooves 856 of the microreplication tool 800 correspond to lines 956 running along the x axis of the design space 900; features 866 disposed on the grooves 856 of the microreplication tool shown in FIG. 8 are indicated in the design space by features 966. Embodiments disclosed herein relate to design techniques for determining the arrangement of the elevated portions (indicated by features 966) in the two dimensional design space 900. The designed arrangement can be mapped to the tool surface which is used to fabricate light directing films.

Some of the 2D design methodologies discussed herein can be compared to one dimensional (1D) designs. A 1D design involves one dimensional pattern of elevated portions. These 1D based patterns can be laid out along a groove as the groove is cut into a tool. During the design process of a 1D arrangement, a minimum and maximum run length may be chosen for the normal prism peak depth, and then, at random locations, an elevated portion of a fixed length and height is generated. Since 2D positioning of these elevated portions on the microreplication tool is not considered in the 1D design process, the arrangement of the elevated portions can go in and out of phase in 2D, producing a combination of random and beat like artifacts. The result is less visual uniformity and the potential for large voids which effect spacer performance.

As discussed in the embodiments herein, a 2D arrangement of elevated portions can be designed, and then the elevated portions can be cut into the microreplication tool according to the 2D arrangement. During the cutting process, the cutting tool actuator signal is synchronized to the position of the microreplication tool. For thread and plunge cut tools one can convert these 2D designs into one or more 1D patterns that encode feature height along each continuous thread. This can be accomplished by simply unwrapping a 2D cylindrical tile along each continuous thread as it helically wraps around the cylindrical design. For thread-cut tools this is often a single continuous thread which spans the whole design pattern. These 1D patterns can then be used to control the depth of a cutting tool as it travels along a particular thread. By syncing the readout of this 1D pattern or patterns with position along the each thread by suitable means, such as by syncing to tool circumferential location, one can control the relative location of features on adjacent threads or on the same thread even over multiple revolutions. In this manner, a 2D arrangement of elevated portions can be designed, converted to one or more 1D data streams for cutting the microreplication tool. The designed 2D arrangement is cut in the microreplication tool during which is subsequently used to form the light directing films.

One 2D design method involves randomly positioning the elevated portions (also referred to herein as “bump features” or simply “features”) in a 2D arrangement. For example, the random pattern might be generated using a pseudo-random number generator to choose positions of the features in the 2D design space. In a random design method, for example, any random location for the start point of a feature may be chosen, with the constraint that each new feature added to the 2D design does not overlap a previously placed feature. However a 2D arrangement formed by random features can produce clusters of features and relatively large voids (areas between the features) due to random clustering.

In some cases, a 2D dithered grid method may be used to design the arrangement of features. According to some implementations of 2D grid-based design, features are laid out on a 2D grid, but the locations of the features are then randomized to be less regular. Another process for grid-based 2D design is to lay out a grid containing a number of possible start points, each start point associated with a given groove count in the cross groove direction (y direction in FIG. 8), and a given an certain encoder count along the grooves (x direction in FIG. 8), and randomly selecting a single start point of a feature per grid-cell. By making the grid-cell aspect ratio such that it contains multiple thread counts one can get a 2D design effect. This design effect can give very uniform layouts and with known void size limits. Grid-based 2D design approaches and films produced by these grid-based approaches are described in commonly owned U.S. patent application Ser. No. 61/369,926 (Attorney Docket No. 66809US002) and PCT patent application US2011/046082, which designates the U.S. which are incorporated herein by reference in their entireties.

Grid-based approaches can be used to produce a light directing film comprising a structured major surface having a plurality of microstructures extending along the surface of the light directing film. Each microstructure includes a plurality of elevated portions and a plurality of non-elevated portions. The elevated portions of the plurality of microstructures have an average length. Each elevated portion comprises a leading edge and a trailing edge along the first direction, i.e., along the peaks of the microstructures. In some embodiments, the light directing film cannot be divided into a plurality of same size and shape grid cells forming a continuous two-dimensional grid. Each of at least 90% or 92%, or 94%, or 96%, or 98% or 100% of the grid cells comprise either a single leading edge of an elevated portion, or a portion of an elevated portion where the elevated portion has a length that is greater than the average length of the elevated portions.

The grid cells can be square or can have other shapes. In some implementations of grid-based design only one microstructure peak is within a grid cell, whereas in other implementations, each grid cell includes peaks of two, three, or more microstructures. In some implementations of the grid-based design at least 50% or 70% or 90% of the grid cells comprises a single leading edge of an elevated portion. In some implementations of grid-based design, fewer than 20% or fewer than 10% or fewer than 5% of the grid cells do not include a leading edge of an elevated portion or a portion of an elevated portion having a length that is greater than the average length of the elevated portions.

Embodiments discussed herein involve approaches for arranging elevated portions for light directing films in a 2D design space. These methods may or may not involve the use of an implied grid that groups possible start points together and from which a single start point is selected during the design process. The techniques discussed herein can be used to obtain light directing films having a uniform visual appearance with reduction of wet-out defects. These visual appearance and reduction of wet-out defects in the disclosed films are due, at least in part, to the void size and feature density characteristics achievable using the methods described below.

Some embodiments discussed, herein do not use grid-based designs or use grid-based approaches in conjunction with non-grid-based approaches for the arrangement of microstructures. For example, in some non-grid-based or partially-grid-based designs, the light directing film cannot be divided into a plurality of same size and shape grid cells forming a continuous two-dimensional grid, where each of at least 90% of the grid cells comprise either a single leading edge of an elevated portion, or a portion of an elevated portion where the elevated portion has a length that is greater than the average length of the elevated portions. In some embodiments, the light directing film cannot be divided into a plurality of same size and shape grid cells forming a continuous two-dimensional grid, where each of at least 80%, 70%, 60%, or even at least 50% of the grid cells comprise either a single leading edge of an elevated portion, or a portion of an elevated portion where the elevated portion has a length that is greater than the average length of the elevated portions.

Examples provided herein are generally based on a microreplication tool that is about 16 inches diameter, although, the methods could be applied to other microreplication tool diameters and/or to other microreplication tool geometries such as flat microreplication tools, for example. Patterns are cut onto the tool with a thread pitch of 24 microns, and a circumferential encoder used to sync the server driven cutting head has a resolution of 18000 counts per revolution. The digital signal driving the cutting head servo is encoded and this encoding is fed into a digital to analog (D/A) converter driving the cutting head servo and synced to the circumferential encoder position.

The resolution of the 2D design space for examples discussed herein is 70.93 microns in the circumferential direction (x direction in FIG. 8) and 24 microns in the cross-cut direction (y direction in FIG. 8). Note that any other resolution could alternatively be used. In the analyses provided below, arrangements for approximately 6656 grooves were simulated which corresponds to about 6.3 inches in the cross-cut direction (y direction) of the microreplication tool. Accordingly, the 2D design area for the arrangements designed in these examples is 6.3 inches×50.27 inches, i.e., 6.3 inches in the cross cut direction and 16 inches*π=50.27 inches in the circumferential direction.

The designed arrangement for the features can be tiled to create a longer cut pattern by concatenating copies of the original digitized signal stream of the initial arrangement. Since the designs discussed in these examples are 2D, there are certain processes that allow the original arrangement to be tiled. In particular, for thread cutting the grooves, a 2D design space arrangement is translated into a digitized signal that controls the cutting tool to cut grooves with bump features into the surface of the microreplication tool. When the next concatenated tile is cut into the microreplication tool, the signal used to control the cutting tool is considered a loop. Portions of bump features that run over the end of the first tile are added to the start of the next tile.

In the 2D design examples discussed herein, the tile is constrained to end on an integral number of tool revolutions (for flat microreplication tools, the integral number of tool revolutions would correspond to the tiling size being used). In the case of a cylindrical microreplication tool, as used in the examples discussed herein, the pattern length for the portion of the surface of the cylindrical microreplication tool that corresponds to the 2D design space is an integral multiple of 18000. Density determinations are performed by assuming that each 2D design space (6.3 inches by 50.27 inches in the examples discussed herein) has copy of itself tiled beside it.

Note that there are two ways of joining tiles around the circumference of a microreplication tool. One method assumes thread cutting the grooves, where the feature patterns are along a single thread that helically wraps the microreplication tool. A second method involves plunge cutting where the microreplication tool is made by a set of grooves that close on themselves. In the plunge-cutting approach, a groove that exits on edge of the tile connects to the same groove as it enters the other edge of the tile. For thread cutting, a groove that exits one edge of the tile enters the other edge offset by one groove, with the last groove on the tile wrapping to the first groove on the tile.

Feature designs based on the linear, random, and grid-based design approaches discussed above were simulated along with additional 2D design methods. Many of the additional design methods tested do not make use of the type of grid discussed in previously incorporated U.S. Patent Application Ser. No. 61/369,926 for determining feature placement, and are thus denoted herein as “grid-less,” or “non-grid-based” designs. The term “grid-less” is used to distinguish these additional designs from those discussed in U.S. Patent Application Ser. No. 61/369,926. In general, 2D designs are constrained in the x and y directions by the pitch of the grooves and the resolution of the tooling used to cut the bumps into the microreplication tool. These constraints limit the possible feature locations in the y direction to microstructure peak locations and limit the possible feature locations in the x direction to the encoder resolution.

One category of “grid-less” design methods is based on generating quasi-random numbers that are used to determine locations of features within the design space. Quasi-random number generators can be used to provide a relatively more uniform arrangement of features in the design space when compared to pseudo-random patterns. Bump arrangements based on quasi-random number generation algorithms including Sobel, Neiderreiter, Halton, Reverse Halton are discussed herein. However, techniques for determining the feature placement are not limited to this set of quasi-random algorithms, and in general any quasi-random algorithm could be used in the design of the arrangement of features. Quasi-random designs tested herein were implemented using algorithms included the GNU Scientific Library.

The process of designing a feature arrangement based on a quasi-random pattern involves, for each i^{th} feature, generating a quasi-random coordinate (x₁ᵢ,y₁ᵢ) and mapping the (x₁ᵢ,y₁ᵢ) coordinate to a quantized groove and circumferential encoder position (x₂ᵢ,y₂ᵢ). For example, the mapping can be achieved by rounding to the nearest groove and possible circumferential position in the design space. A feature may be positioned starting at the point (x₂ᵢ,y₂ᵢ), or other reference points of the feature, e.g., end or mid-point, may be positioned at the point (x₂ᵢ,y₂ᵢ). The process of placing the features in the design space is iteratively repeated for all M features in the feature arrangement, i.e. across i=1 to N, where N is the total number of features in the arrangement. The feature heights may be dithered, although in some cases, dithering may be 0 corresponding to a constant feature height. For all of examples described herein, a constant value was used for the feature height (dithering=0).

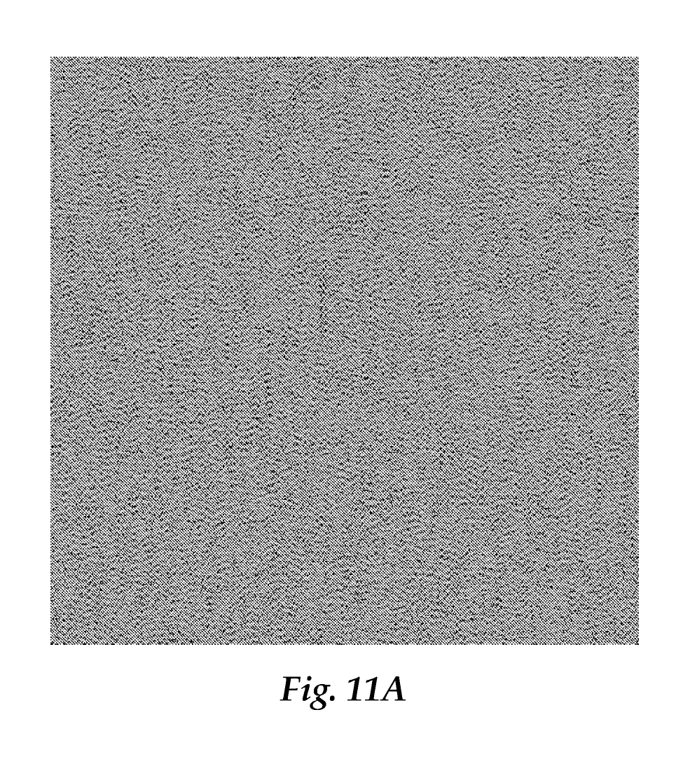

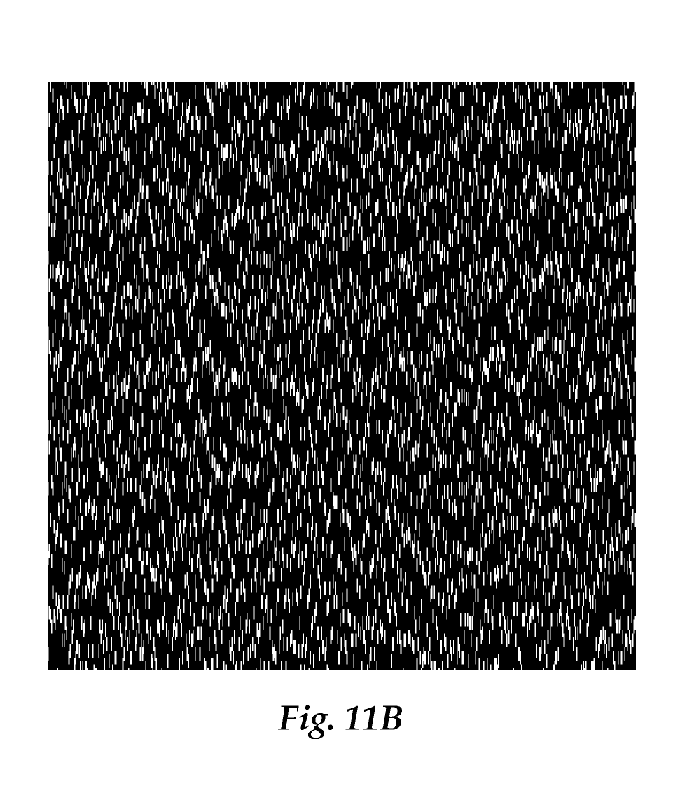

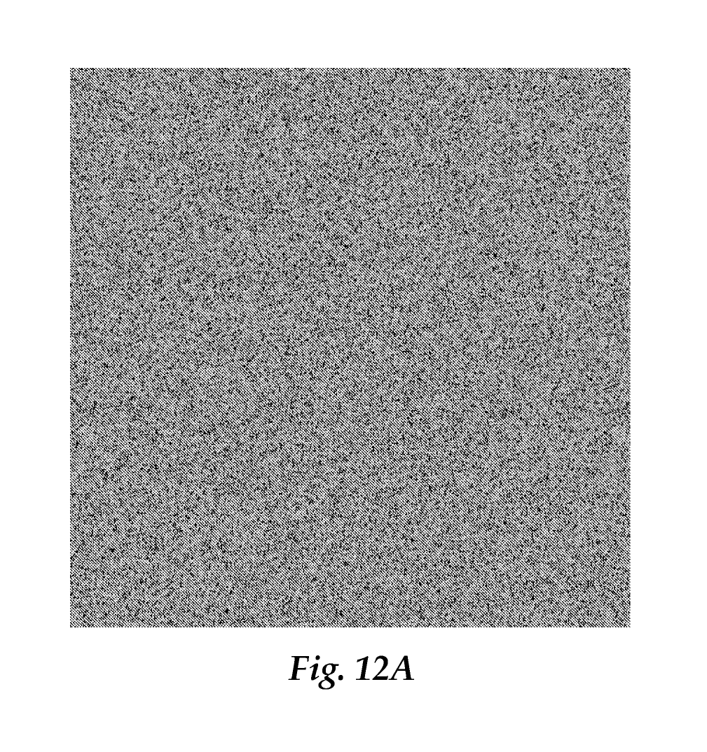

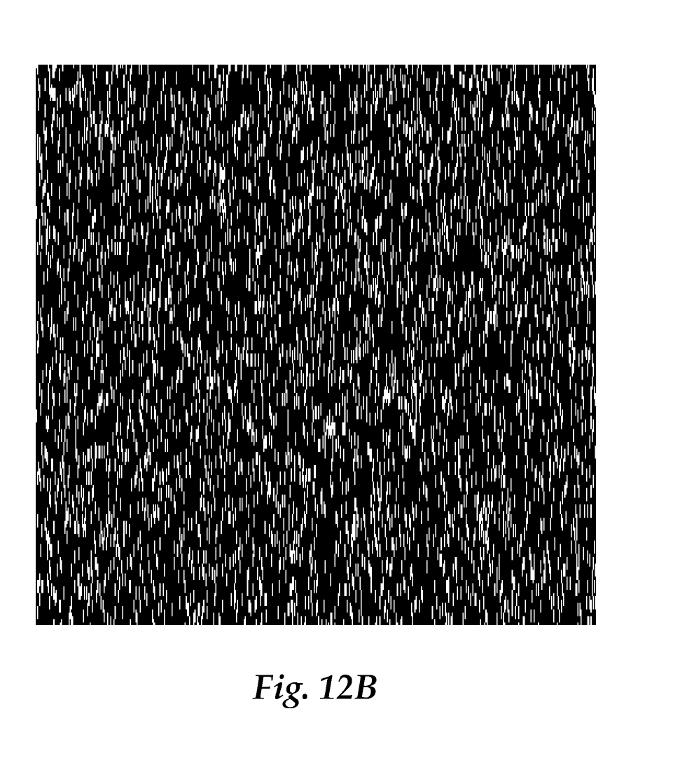

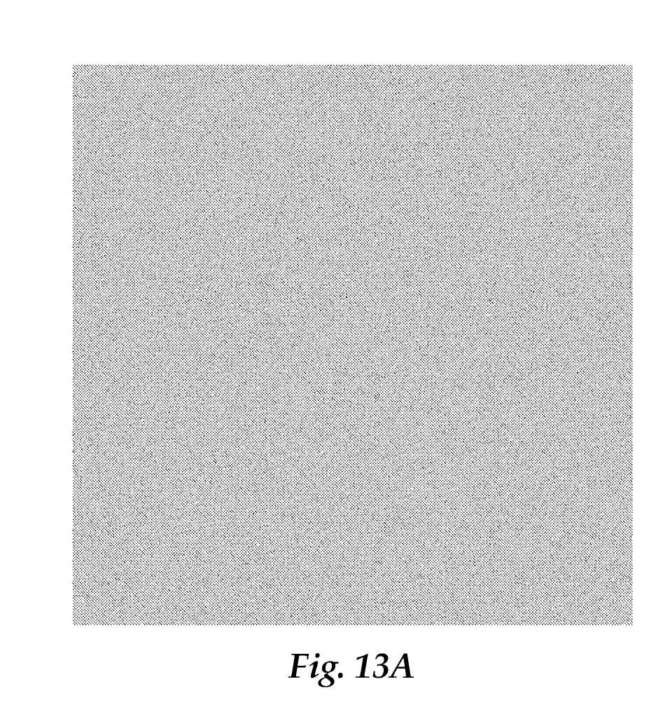

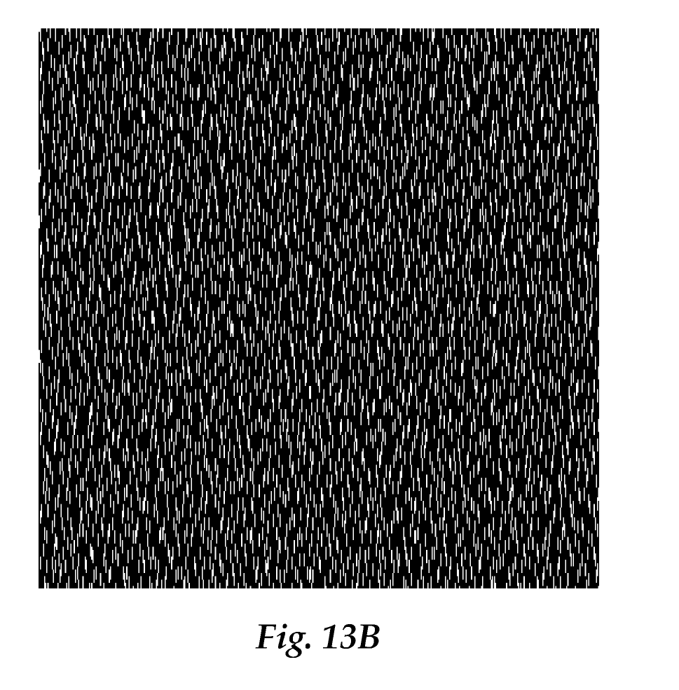

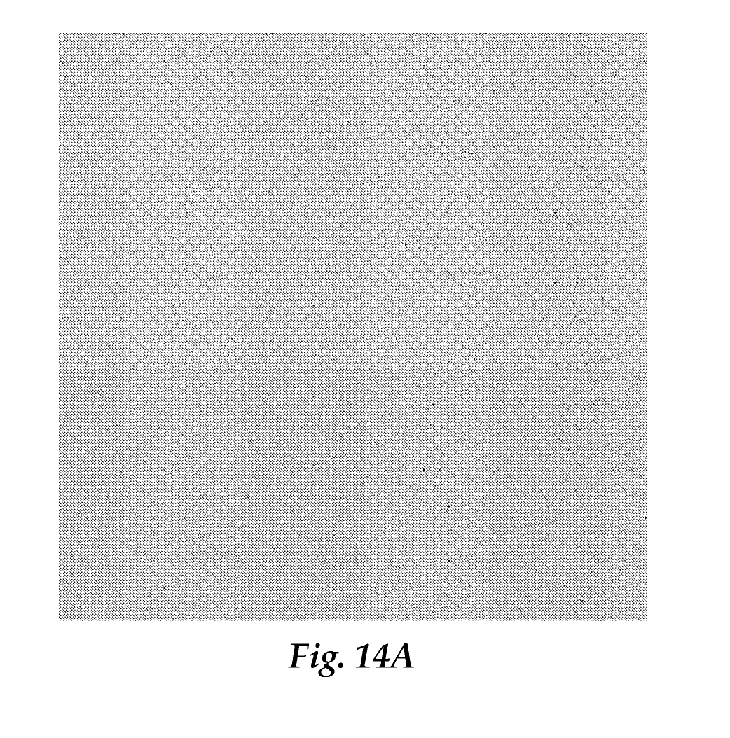

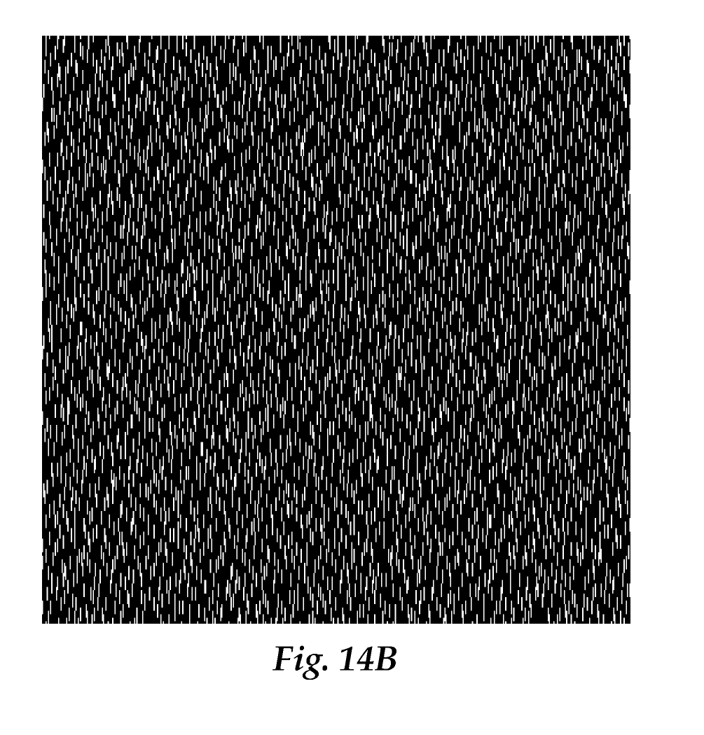

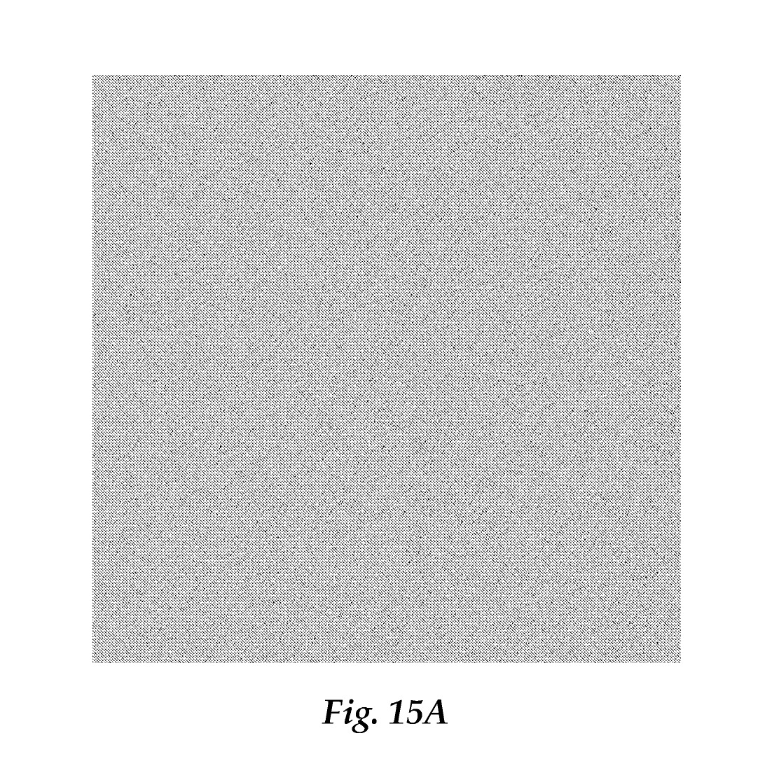

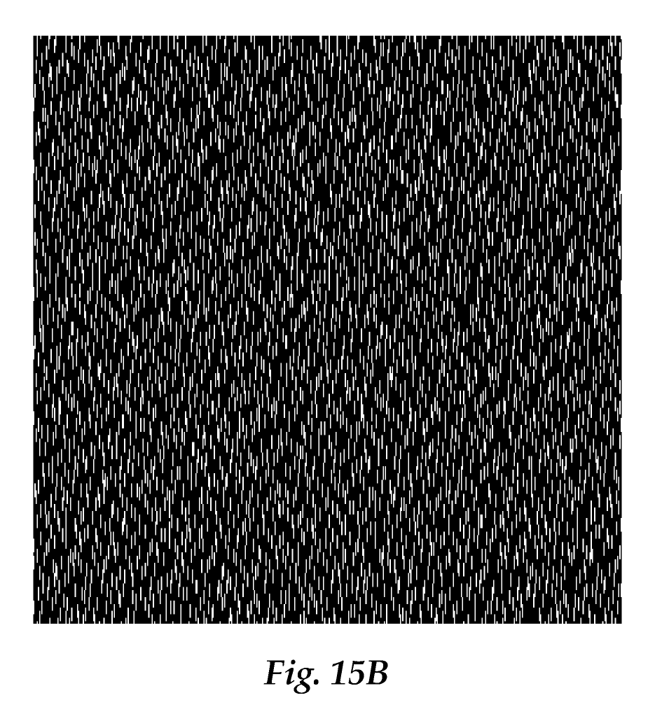

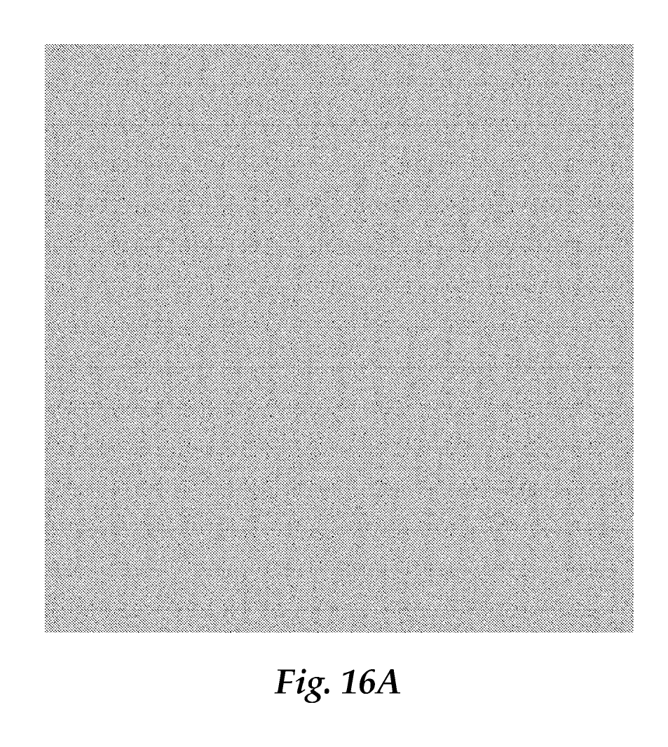

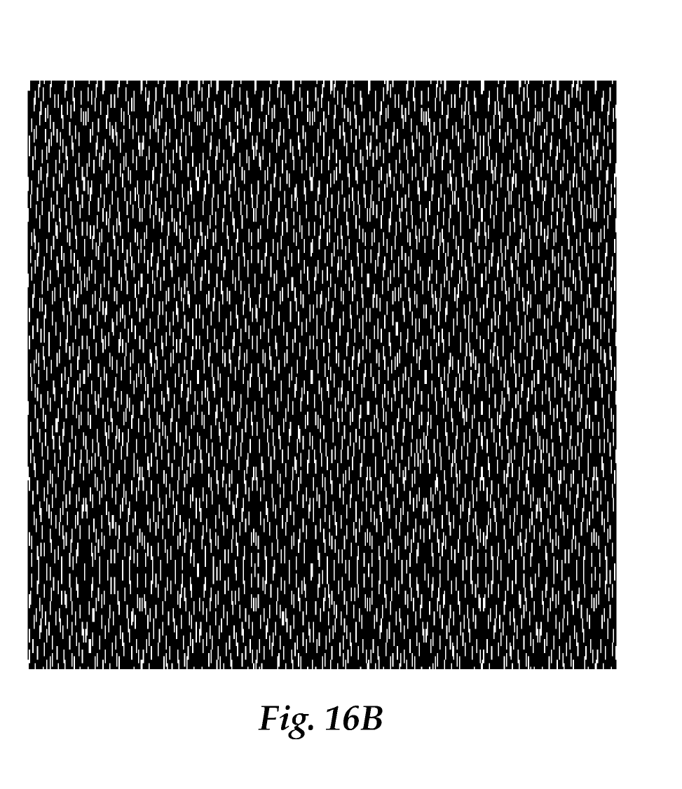

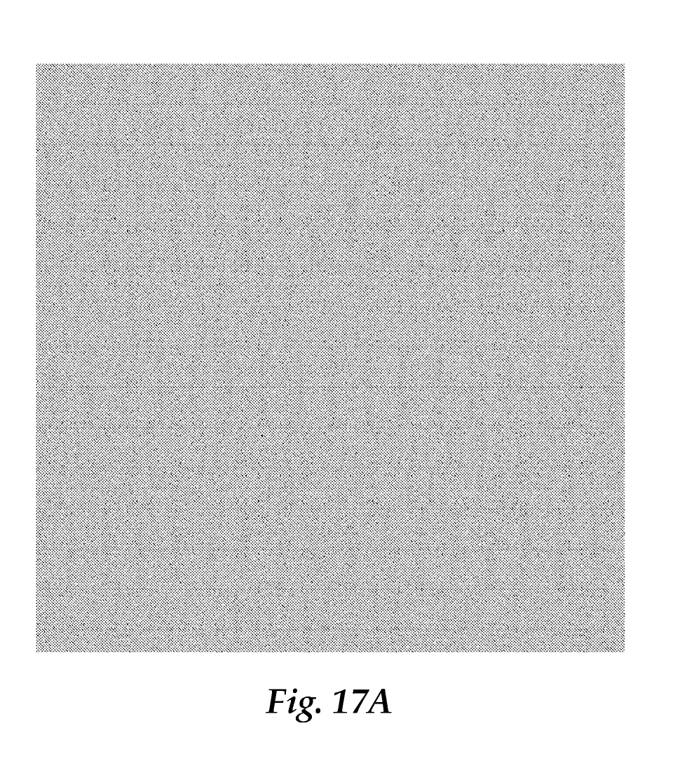

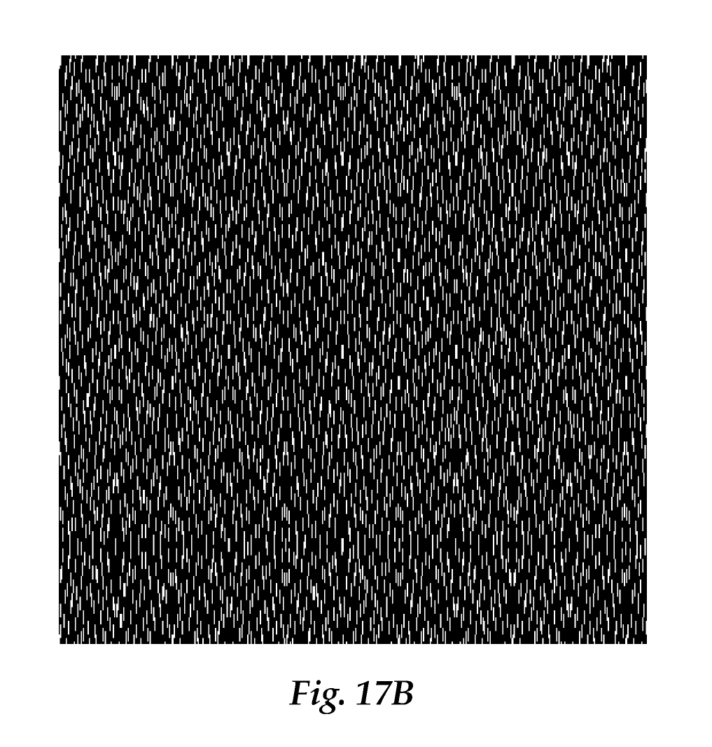

Bump arrangements were simulated using the above method based on quasi-random algorithms Halton, Reverse Halton, Sobel, and Neiderreiter. These feature arrangements are visualized in low and high resolution for feature arrangements based on the Halton method (FIG. 14A (low resolution, FIG. 14B (high resolution)), Reverse Halton (FIG. 15A (low resolution, FIG. 15B (high resolution)), Sobel (FIG. 16A (low resolution), FIG. 16B (high resolution and Neiderreiter (FIG. 17A (low resolution), FIG. 17B (high resolution)). For comparison, feature arrangements designed using the 1D linear method (FIG. 11A (low resolution), FIG. 11B (high resolution)), the random method (FIG. 12A (low resolution), FIG. 12B (high resolution)), and the grid-based method (FIG. 13A (low resolution), FIG. 13B (high resolution)) were also simulated. A feature number density of approximately 2447/cm² was used.

The visual results are provided by 512×512 pixel images in two different resolutions. For the feature arrangements visualized. the high resolution images, shown in FIGS. 11B, 12B, 13B, 14B, 15B, 16B, 17B, have pixels that are 24 microns per pixel wide (which is the cross-thread direction), and approximately 23.64 microns in the height direction (which is the circumferential direction). These dimensions were chosen so that the high resolution image has no aliasing (at least in the original source image). These 512×512 images correspond to viewing about 0.5 inches per side. The low resolution images, shown in FIGS. 11A, 12A, 13A, 14A, 15A, 16A, 17A are also 512×512 pixels in size and were designed to be about 80 dots per inch (dpi). The low resolution images view a physical area of about 6.4 inches on a side. The images of FIGS. 11-17 are representations of an average value of the elevated portions and non-elevated portions that lie within an area covered by a pixel. The images shown in FIGS. 11-17 are gamma corrected to a gamma of 2.0 so that the brightness of the image would be roughly proportional to average feature depth over the area.

It will be appreciated upon viewing the simulations of FIGS. 11-17, that the feature arrangements produced using the grid-based and quasi-random design methodologies (Halton, Reverse Halton, Sobel, and Neiderreiter) visually show superior uniformity in feature arrangement when compared to the linear and random methods. Feature arrangements designed based on different quasi-random algorithms can result in different visual uniformity results. These differences can be further accentuated when the various quasi-random algorithms are applied in conjunction with fundamental periodic patterns associated with the resolution of the tooling, the pixel pattern used in viewing images, and/or other periodic components in a display system. As one example, the feature arrangement produced using the Reverse Halton series seems to have good visual appearance with substantially random distribution of features with little feature clustering, but it appears that the Sobel and Neiderreiter series can produce feature arrangements having periodic visual artifacts which may be undesirable in some applications.

Another design method for feature arrangement involved placement of features constrained by placement rules that operate to space out (de-cluster) the features across the design space. The group of feature arrangement design methods that use these de-clustering rules are collectively referred to herein as “constrained placement” methods. In one constrained placement design method, coordinates that are based on a random selection are used as the start points of the features. For each i^{th} feature to be placed in the design space, a random coordinate (x₁ᵢ,y₁ᵢ) is generated. The random coordinate is mapped to a quantized groove and circumferential encoder position (x₁ᵢ,y₁ᵢ)→(x₂ᵢ,y₂ᵢ) by rounding to the nearest thread and possible circumferential position in the design space. Placement constraint rules are applied and mapped feature locations (x₂ᵢ,y₂ᵢ) are selected or rejected based on whether or not the adjusted feature location (x₂ᵢ,y₂ᵢ) meets the placement constraint rules. If a feature location coordinate is selected, then a feature is placed at that location in the design space. The process of identifying an initial coordinate for the features, mapping the initial coordinate to a quantized groove and circumferential encoder position, and applying the placement constraint rules is iteratively repeated for all N features in the feature arrangement, i.e. across i=1 to N, where N is the total number of features in the arrangement.

In some implementations of the constrained placement method, locations of the features are constrained to be at least a predetermined distance from other, previously placed, features. Thus, each proposed feature location (x₂ᵢ,y₂ᵢ) that is farther away than a predetermined distance from a nearest neighboring feature would be selected and each proposed feature location (x₂ᵢ,y₂ᵢ) that is closer than a predetermined distance from a nearest neighboring feature would be rejected.

For example, in one implementation, the constraint rules include that the distance between the centerline of a proposed feature to a centerline of an existing feature must be greater than a predetermined distance. Other distance metrics may alternatively be used, such as distance between the start points of the features in question, or any other metric which increases monotonically with distance or a distance-like metric. For features having anisotropic shapes, i.e., a feature having a width that is less than the feature length, the centerline distance constraint discussed above implicitly takes into the account the anisotropic shape of the features, unlike the previously described quasi-random techniques. Alternatively, the distances between start points of the features (or some other location) could be measured, although these constraint rules would ignore the effects of anisotropy in the feature shape.

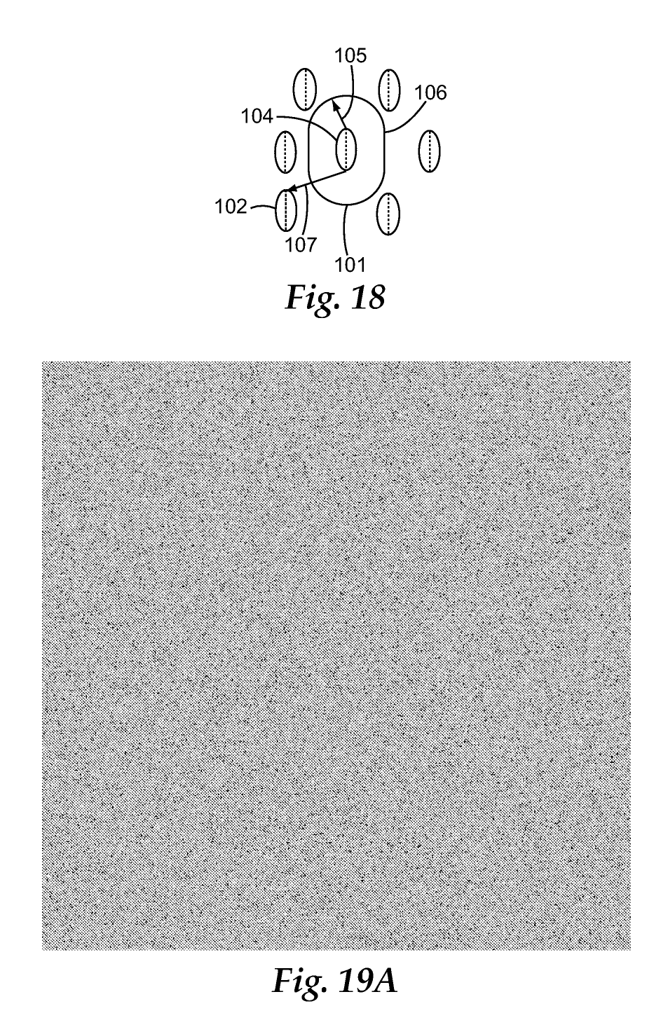

An example of the constrained placement method is illustrated in FIG. 18. FIG. 18 shows an exclusion zone 1806, around feature 1804, the exclusion zone 1806 having a radius of 1805. If the distance 1807 between any of the previously placed features 1802 and the proposed feature 1804 is less than the radius of the exclusion zone 1805, then the proposed feature would be rejected. A useful spacing distance R (R is the exclusion zone radius 1805) can be estimated based on the number of features N, total area to fill with features A, the length of the features L, and fractional scaling factor F. In particular:

$$R = 2 F [ \frac{\sqrt{\frac{A}{N} π + {L}^{2}} - L}{π} ]$$

In the equation above, F is an arbitrary scaling factor in the range of 0 to 1 indicating how uniformly and widely each placed feature should be spaced. A value of 0 is equivalent to random placement with no separation limits, and higher values of F reduce feature clustering. Bump arrangements designed with F in the 0.2 to 0.4 range tend to allow free enough feature placement flexibility so that all of the features can be placed with position searches that can successfully place a feature in 200 or fewer random tries, while also providing an amount of feature separation. Higher values of F have more and more difficulty of finding a viable feature location, and therefore design time increases dramatically. For example, for

$$F = 0.4 , \frac{A}{N} = \frac{1}{2447} {cm}^{2} ,$$

and L=4*70.93 μm=0.2837 mm, R=1.29 mm. As another example, for

$$F = 0.6 , \frac{A}{N} = \frac{1}{2447} {cm}^{2} ,$$

and L=4*70.93 μm=0.2837 mm, R=1.93 mm.

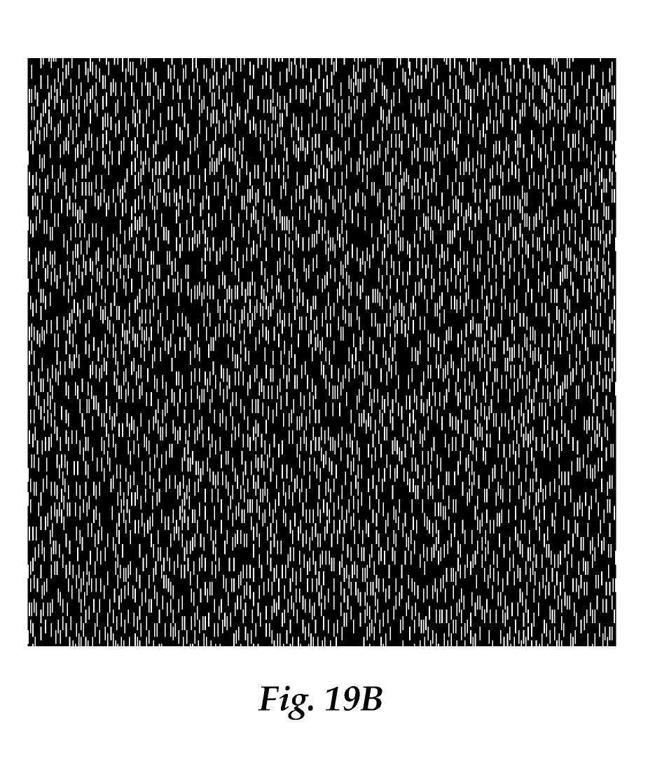

In one example feature arrangement design, a design space including 6656 grooves was simulated using a minimum separation of Factor F of 0.4. The patterns resulting from this design are shown in low resolution in FIG. 19A and in high resolution in FIG. 19B.

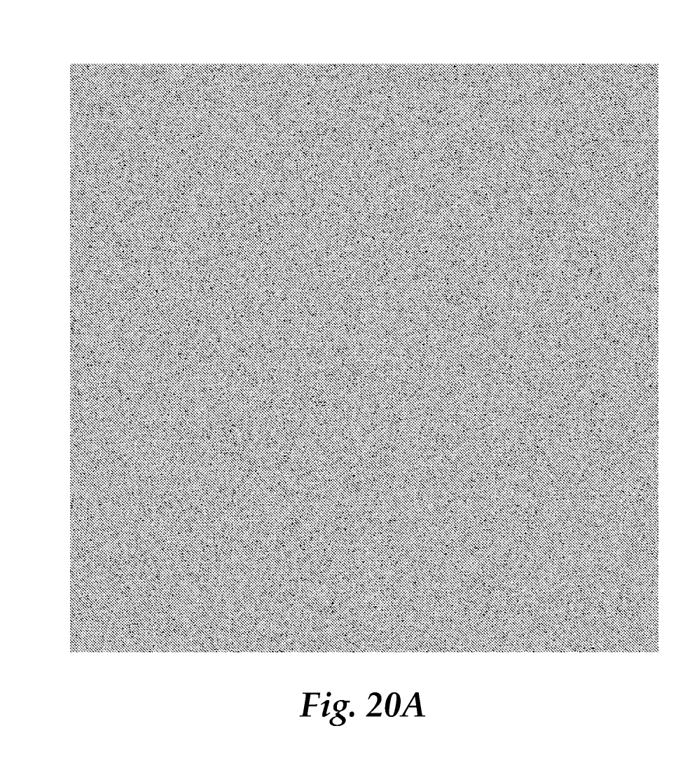

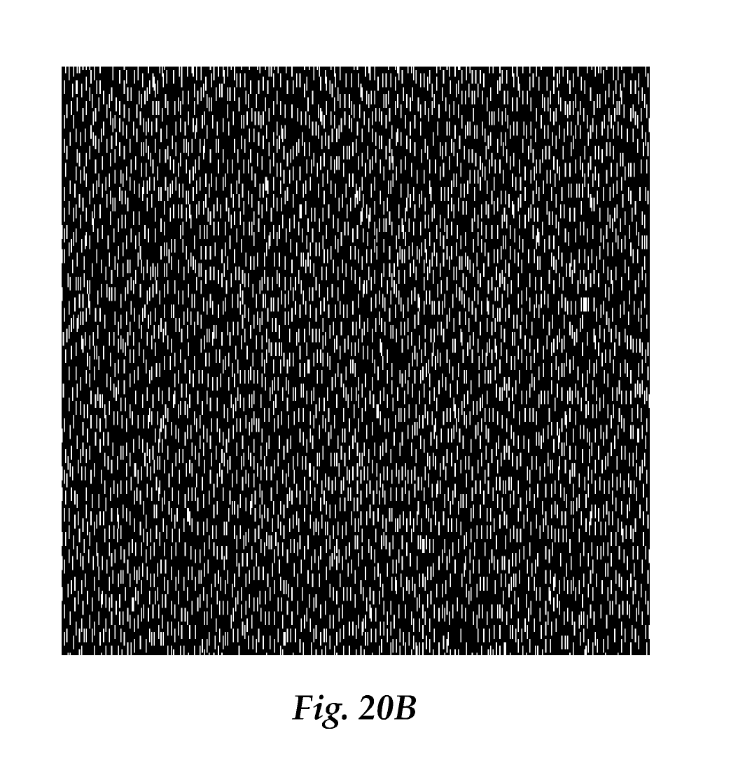

In another placement method, denoted the Best of K technique, for each feature placement, K random location selections are made and then the location that is furthest from previously positioned features is used as the final feature location. The low and high resolution results for this technique with K=10 are shown in FIGS. 20A and 20B, respectively. In alternate implementations, a variable K could be used. For example, K may increase with the number of features that have been placed. The value of K can be used to tune the relative tradeoff between regularity of the feature locations and the randomization of the feature locations.

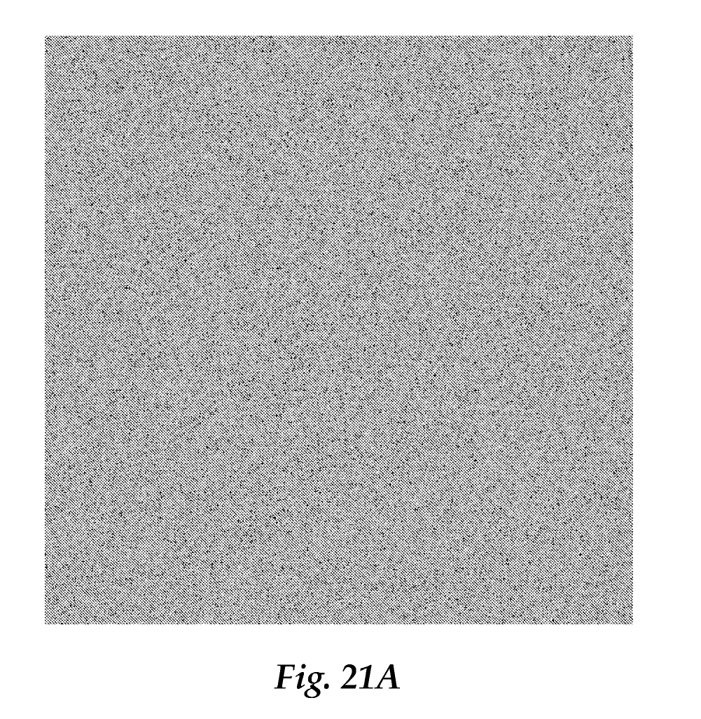

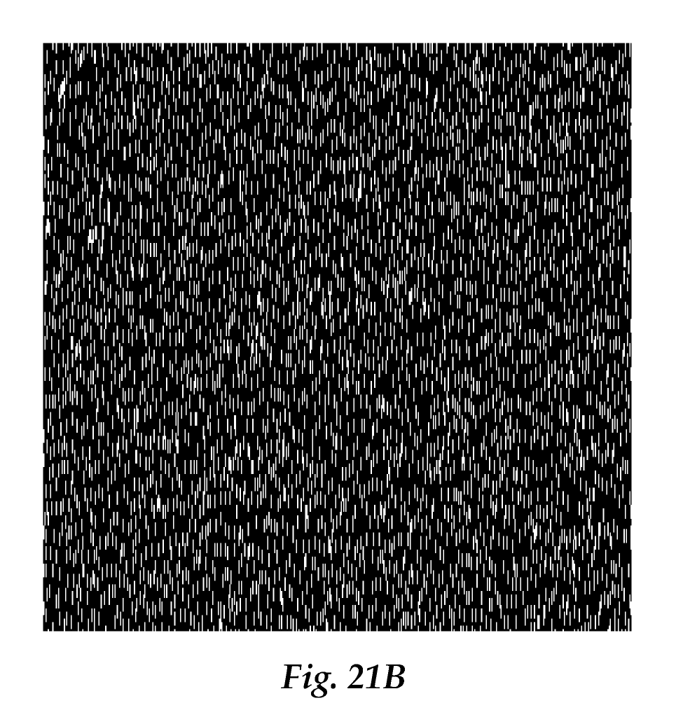

Yet another approach for feature arrangement design is to use a hybrid method where one design method is used to do an initial feature layout for some fraction G of the total N features in the design, and then the locations of the remaining H features are determined using a different method. FIGS. 21A and 21B show in low and high resolution, respectively, the result of using a hybrid method that includes the random placement design technique for the first 50% of the features and then using the constrained spacing design technique for the remaining features. There are of course many variations of the hybrid method, including various combinations of the design techniques discussed herein. Two, three, or more techniques may be used to determine the locations of two, three, or more sets of features. For example, the random placement technique could be used for the first set of feature locations of the design, the constrained spacing placement for a second set of feature locations, and the Best of K method may be used for the last part of the design.

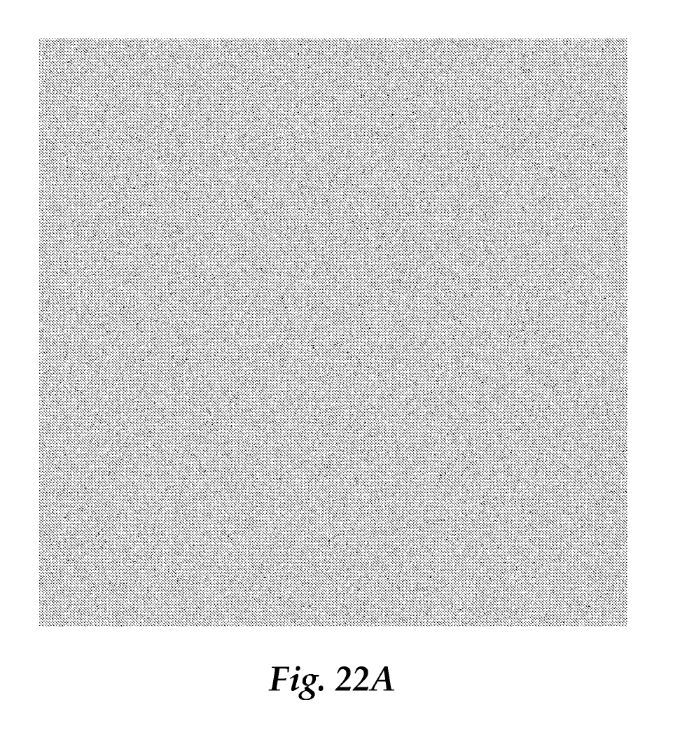

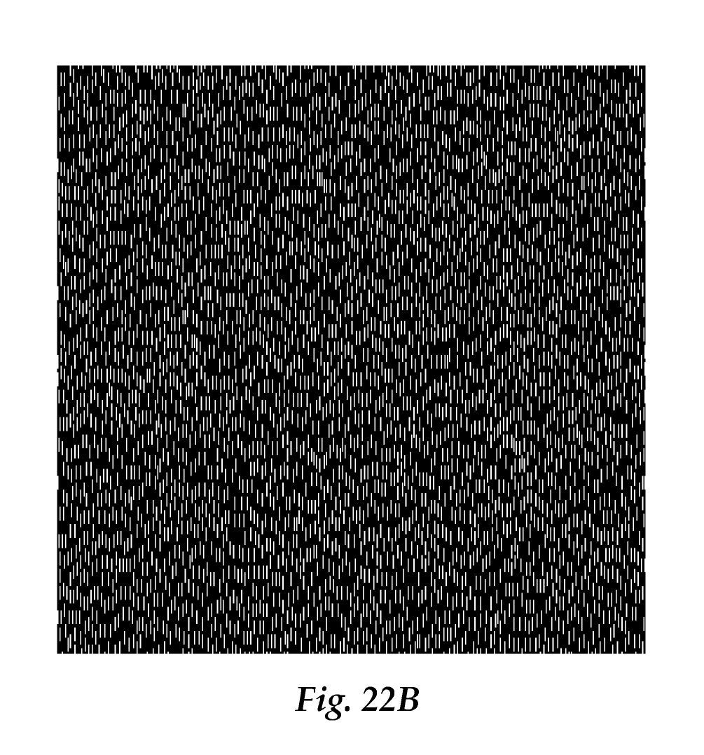

Yet another approach is to use a combination of constrained placement and Best of K techniques together in such a way that initially only locations that satisfy the minimum distance criterion are selected, but if the minimum distance criterion is not met for K possible locations, then the best location, e.g., the one that is the furthest from previously placed features for example), is selected from the K possible locations. Thus, this design methodology can be used to switch from one technique to another in response to some event or parameter, such as when the feature placements become more difficult as more and more features are added to the arrangement. FIGS. 22A and 22B, respectively, show low resolution and high resolution results for this constrained placement/Best of K hybrid methodology based on a scaling factor of F=0.6, and with a limit of K=200.

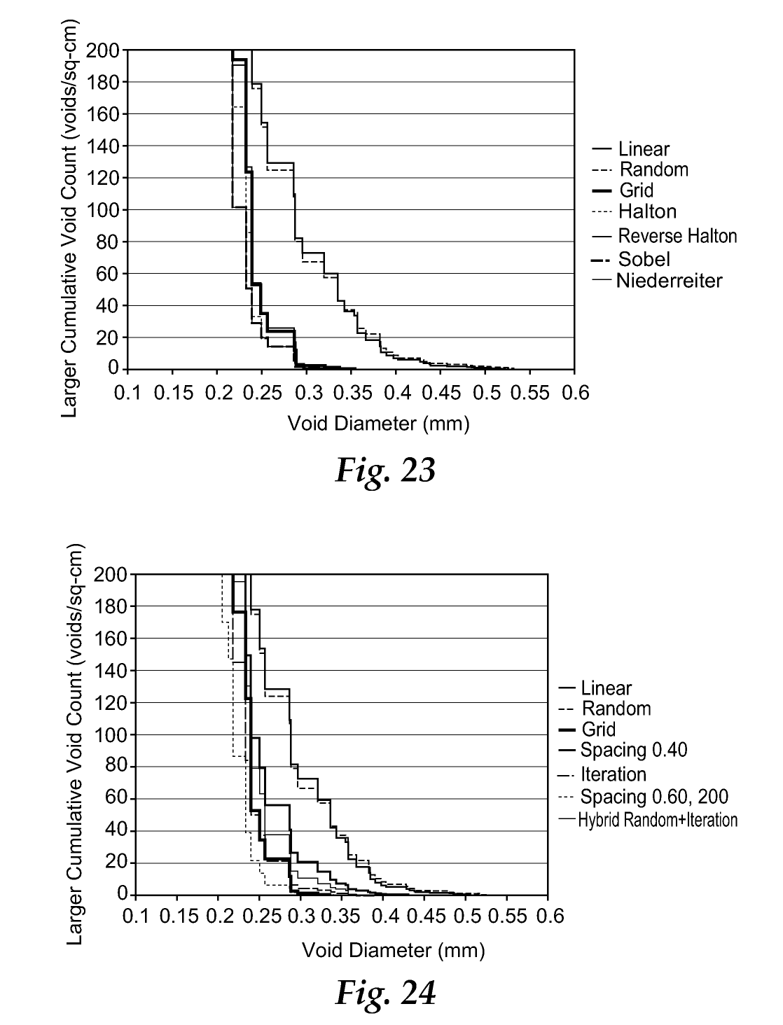

The average size, maximum size, and density of voids in a given area of a feature arrangement can be quantified using cumulative frequency plots of void size. FIGS. 23 and 24 compare the void size distributions produced by various design methods. These plots show the cumulative frequency of all voids by diameter starting with the largest voids. Voids are considered to be non-overlapping circular regions that do not include any portion of a feature. For example a void size of 0.5 mm means that a circle having a diameter of 0.5 mm can be overlaid on the feature arrangement within encountering any portion of a feature.

Computationally, the circular regions (voids) were found by scanning all of a plurality of sub-regions in the feature arrangement and determining the distance between the sub-region center point and the centerline of the nearest feature. This distance is the radius of the void. All voids identified by this process were sorted in decreasing order by diameter and then the overlapping regions were eliminated by traversing the list in order (of decreasing radius), and comparing the current region to all previous non-overlapping regions. If the current region was then non-overlapping, it was added to the final list of non-overlapping regions. Any useful sub-region resolution may be used when searching for center points. In FIGS. 23 and 24, the quantized resolution of the original design pattern was used for simplicity to determine the sub-regions (70.93 microns in the circumferential direction (x direction) and 24 microns in the cross cut direction (y direction)). Other sampling methods such as Monte Carlo methods can be used, for example. In FIGS. 23 and 24, the voids added to the final list were counted based on cumulative frequency and the result was normalized by area. FIGS. 23 and 24 show cumulative frequency plots by the diameter of feature free voids calculated in this way. The plots are quantized since the underlying sub-regions used for the calculation is discrete. The same quantization was used for both design and analysis. An area roughly the size of a 3″ diagonal was analyzed to produce the plots.

FIG. 23 focuses on the quasi-random design methods based on the Halton, Reverse Halton, Sobel, and Neiderreiter algorithms and compares these design methods to the linear, random, and grid-based methods. FIG. 24 compares various placement methods, including the constrained spacing method using F=0.40, the Best of K iterations method, a hybrid method that includes both the constrained spacing method with F=0.60 implemented in conjunction with the Best of K method with K=200, and a hybrid method that places a first fraction of the features using the random method and a second fraction of the features using the Best of K method.

As will be appreciated from FIG. 23, the grid-based and quasi-random methods all reduce maximum void size for a given feature density and feature length compared with the random and linear methods. As will be appreciated from FIG. 24, the various 2D placement methods reduce maximum void size for a given feature density and feature length when compared to the random and linear methods. There are also some differences between the various methods in the maximum void size. The maximum void size for each design technique is provided in Table 1.

TABLE 1

| Placement method | Max Void Diameter (mm) |
|---|---|
| Neiderreiter | 0.321 |
| Sobel | 0.321 |
| Grid-based | 0.336 |
| Reverse Halton | 0.355 |
| Halton | 0.358 |
| Constrained spacing, F = 0.6 + | 0.358 |
| Best of K, K = 200 | |
| Random + Best of K iterations, | 0.384 |
| K = 10 | |
| Best of K, K = 10 | 0.390 |
| Constrained spacing, F = 0.4 | 0.432 |
| Linear | 0.523 |
| Random | 0.532 |

As can be appreciated form TABLE 1, the Sobel and Neiderreiter methods did the best at reducing maximum void size, but introduced some artifacts that may be objectionable in some cases. The grid-based method can produce good uniformity. The Halton, Reverse Halton, and the constrained spacing, F=0.6+Best of K iterations, K=200 all produced similar results for maximum void size. The various Best of K methods including Best of K with K=10, and the hybrid Random+Best of K method that starts by placing 50% of the features randomly and completes with Best of K, for K=10 produced similar results. Finally the constrained spacing 0.4 placement method appeared to be not as good at some methods at fitting features, presumably because this method did not allow dithering of the minimum space allowed in these specific examples, whereas the various Best of K methods include some intrinsic dithering due to the iteration limit. Finally, the random and linear methods produce similar results with relatively large maximum void sizes for a given feature length and density.

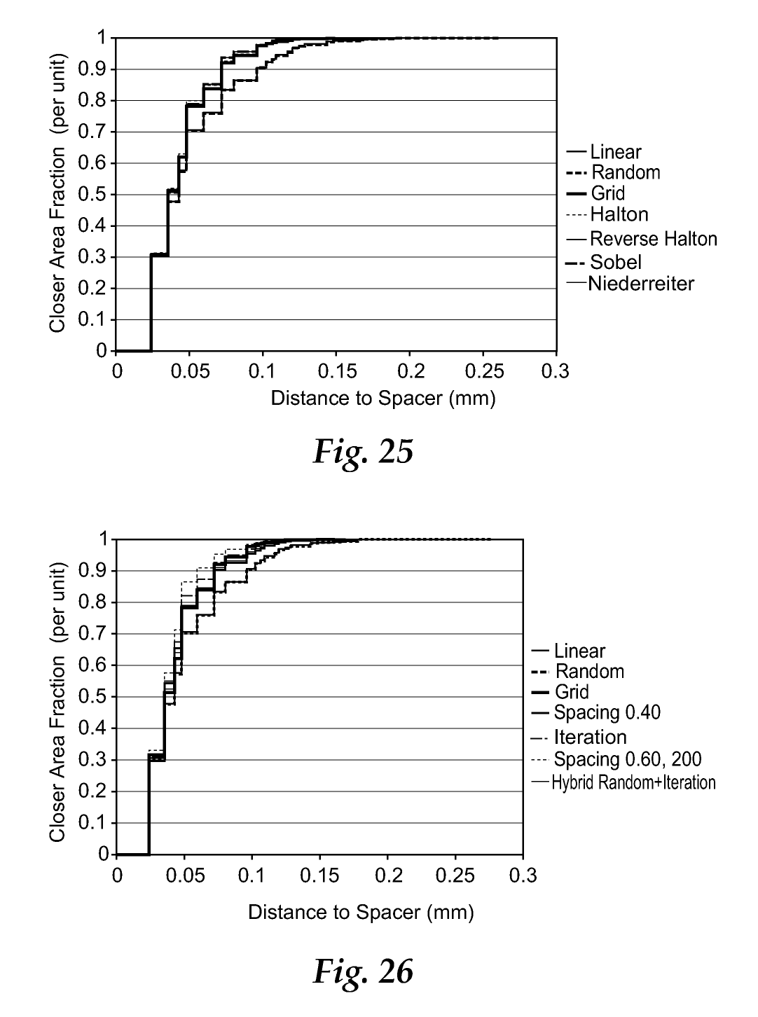

An alternative method for analyzing void size is to plot cumulative fractional area versus distance to the nearest feature. For this analysis, the design space of the feature arrangement was divided into a number of sub-regions. For example, the quantized resolution of the original design pattern may be used to determine the sub-regions (70.93 microns in the circumferential direction (x direction) and 24 microns in the cross cut direction (y direction)). Similar results can be determined in a variety of ways including Monte Carlo sampling of the region, or a higher resolution could be used, for example. FIGS. 25 and 26 show the cumulative area plots.

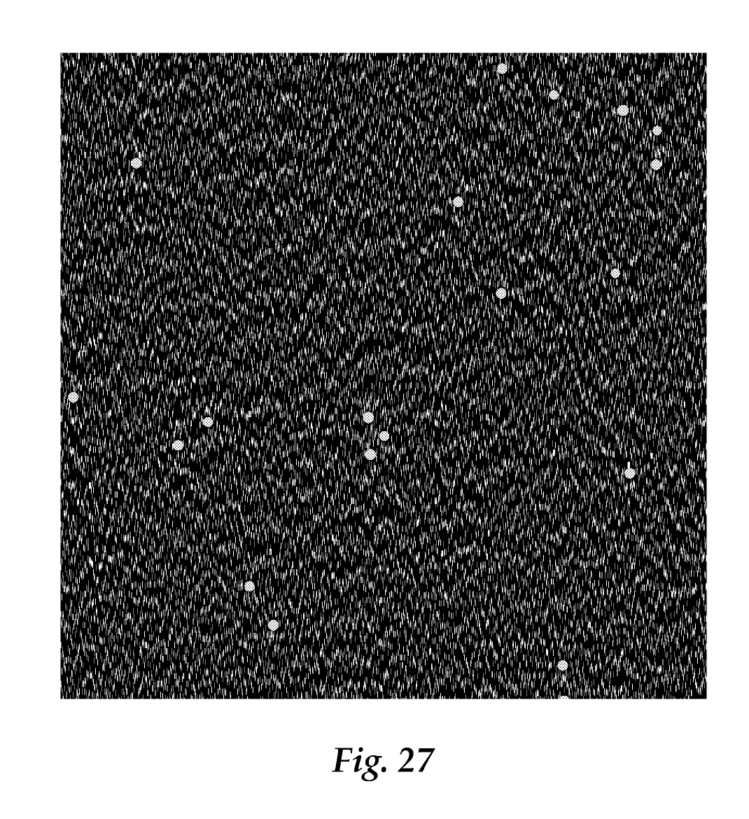

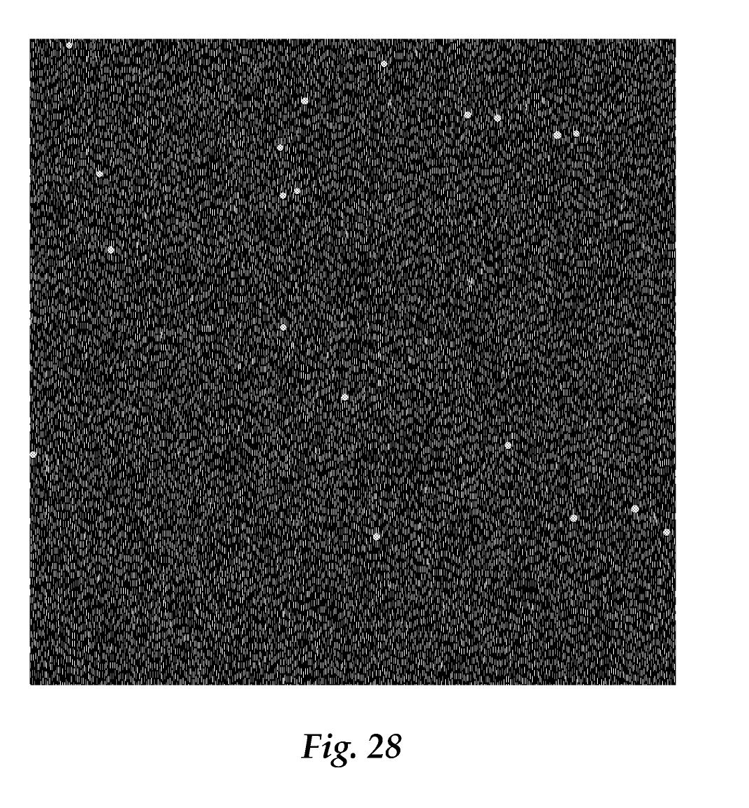

To visually illustrate the significance of the constrained spacing, F=0.6+Best of K, for K=200 method compared with linear method, consider FIG. 27 and FIG. 28. FIG. 27 shows the 20 largest voids found in a 3 inch by 3 inch region having a feature arrangement designed using the linear design method. FIG. 28 shows the 20 largest voids found in a 3 inch by 3 inch region having a feature arrangement designed using the constrained spacing, F=0.6+Best of K, for K=200 method. Comparison FIGS. 27 and 28 shows that the void sizes using constrained spacing, F=0.6+Best of K, K=200 method shown in FIG. 28 are much smaller than the voids produced by the linear method shown in FIG. 27.

Returning to the cumulative plots shown in FIGS. 23 and 24, it is apparent that there tend to be a small number of voids that are large compared to most other voids. One approach to further reduce these large voids is to retrospectively identify the largest voids in the feature arrangement design and then add one or more features within these voids. The initial design can be achieved using any grid-based or non-grid-based technique.

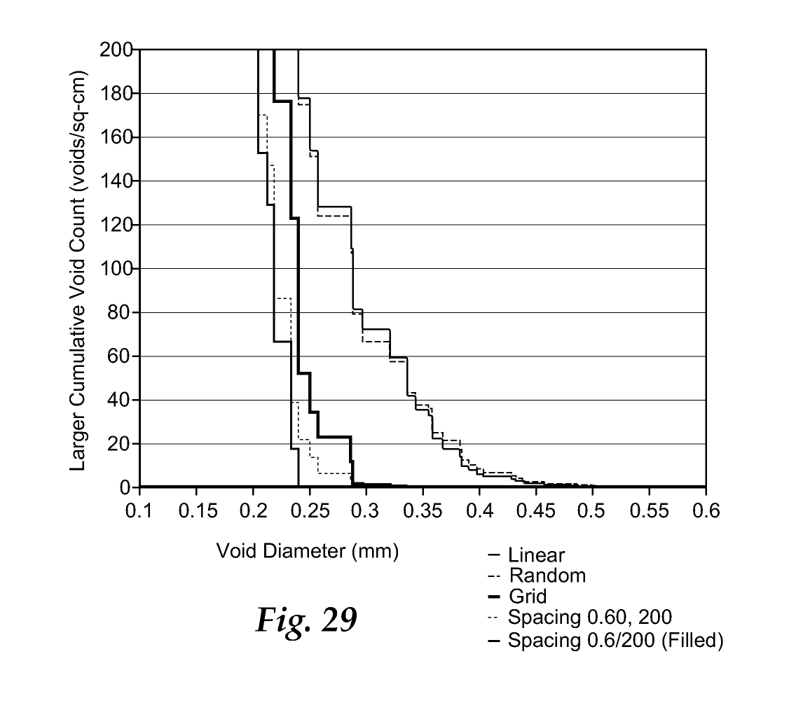

As an example of retrospective filling, initially the design method of constrained placement with an F value of 0.6 in conjunction with a limit of K=200 was used. Using this base design, a single feature was retrospectively added at the center of each void greater than 0.25 mm, i.e., each non-overlapping circular region with a diameter greater-than or equal-to the 0.25 mm. Eliminating a large void and/or filling a void within an odd shaped region, can generate additional voids that may also be filled. To deal with this phenomenon, the retrospective void-filling procedure was iterated until no additional voids greater than 0.25 mm were found. In the example case, the void-filling required two iterations. The result was that the largest void size decreased from 0.358 mm to less than 0.250 mm with the addition of approximately 20 features per square centimeter. This was a less than 1% feature density increase which resulted in an additional 30% decrease in the largest void. Compared with the linear design method, the combined maximum void size decrease is about 52%. FIG. 29 illustrates the result using the retrospective void-filling process for the initial design of constrained placement with an F value of 0.6 in conjunction with an iteration limit of K=200 with voids greater than 0.25 mm retrospectively filled with an additional feature. For comparison, the results from the linear, random, grid-based and constrained placement with an F value of 0.6 in conjunction with a limit of K=200 without retrospective void filling are also shown in FIG. 29.

The previous discussion has focused on the design of feature arrangements and has provided some simulations of example feature arrangements. When the feature arrangements are cut into a microreplication tool, the physical depths of the features are controlled by a servo system which has its own characteristic behavior including, for example, an impulse response. The resulting tooling is then used to make film in some process of replication, and again the replication has its own characteristics. The consequence of the translation from ideal feature arrangement to light directing film is that feature shapes will not necessarily be formed as sharp transitions, but may have more gradual transitional regions, and/or may have depth profiles which are not uniform.

When measuring a feature position, the distance between features, and the areas of voids on a light directing film, more general conventions than circular encoder positions for example, or location of a groove on the resulting produced film. Nevertheless, feature arrangements produced by the design methods discussed here will generally be positioned in one direction corresponding to the groove (microstructure) direction, e.g., the circumferential direction, and in the other direction corresponding to the cross-groove (cross-microstructure) direction.

Using the along groove direction and cross groove directions to characterize points on the feature arrangement, or microreplication tool for a light directing film, in one direction, e.g., the groove direction, the feature with have a cross-section profile along that direction that is similar across its length, although depth and cross-section may vary. However, the radius of curvature at the deepest point of the cross-section and/or other shape factors near the deepest point will be substantially the same. There will be a line along which the cross-section of the groove is the deepest, and one can arbitrarily define this as the center of the “groove”. Adjacent grooves are separated by a characteristic “pitch” which is the mean spacing of the nearest groove center-lines.

Depth profiles in the along-groove direction may be more complicated, however, a profile along the center-line of the groove, i.e. the deepest part, can be created. Various characteristics, such as the location of maximum depth, and/or the start and/or end of the grooves at 50% height of the feature relative to the feature-free nominal distance or similar metrics for the features in the along groove direction can be developed. Length of the features can be defined as the distance between the start and end locations based on this half-height definition (or some other criteria).

These examples discussed herein provide working definitions and other definitions that are self-consistent and give a reasonable definition of feature position and length can be alternatively used. For example, a feature may be defined in terms of its start point, and length, although other metrics, such as end point and/or maximum location could be used. The usefulness of these definitions is that the start point of each feature in the design falls on one of a plurality of possible locations in design space. In the cross groove direction, the resolution of the possible locations corresponds to the groove pitch and in the along groove direction, the resolution of the possible locations corresponds to the circumferential encoder resolution in the along groove direction.

The features will also have a characteristic length, though this length will not necessarily be an integral multiple of circumferential encoder steps. All of these locations and lengths can be measured on actual film in the laboratory. The approaches described herein define feature arrangements including a number of features, feature locations, feature number densities, and feature lengths. Since these characteristics can be reasonably well defined, the methods used to create cumulative void count and cumulative area plots can be extrapolated from the simulations discussed herein to actual light directing films so long as the characteristics such as number density, and feature length are correctly identified.

The examples provided above focus on a given feature density, however, the results in terms of void diameter and distance to features scale inversely with the square root of the number density for features for metrics that do not include feature length or for those that include feature length and the feature length is small compared to the separation.

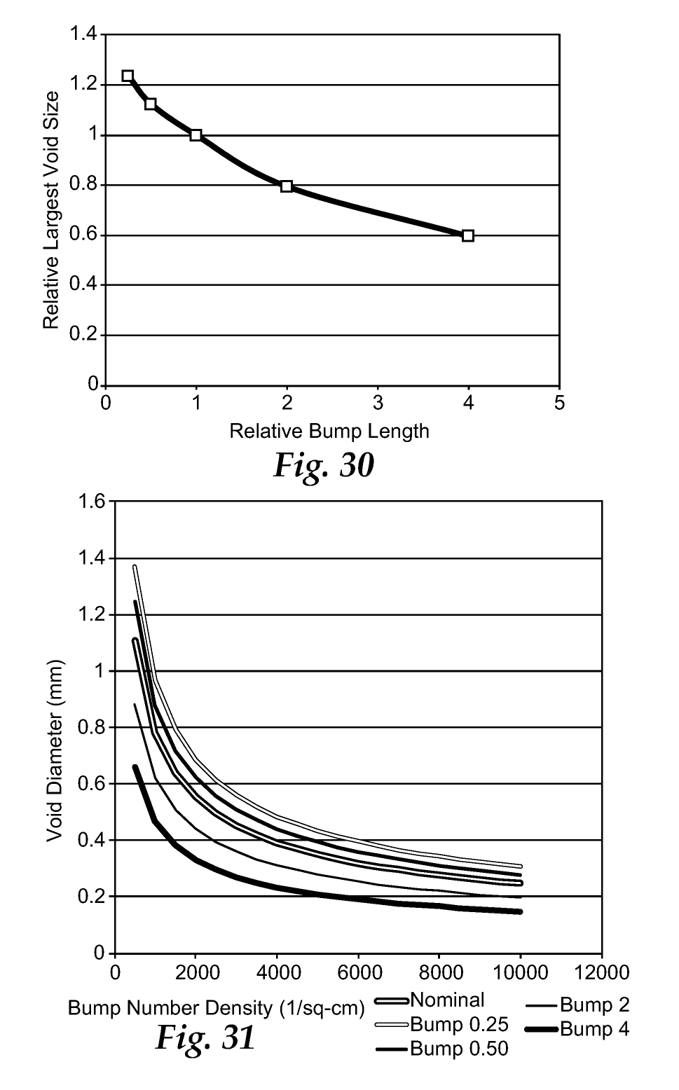

The number-of-voids scale in proportion to the number density. For metrics that include feature lengths the consideration of feature length with tend to reduce distances somewhat compared to those design methods that assume zero feature length, or design methods using shorter feature length. FIG. 30 shows the dependence of relative maximum void size versus relative feature length using a random layout method and our standard base-case as the center point. In particular, this is based on 2447/cm² and a base feature length of 0.2837 mm. This estimate does use a slightly different random design method than previously described. In particular in this estimate it was not required that the randomly placed features not overlap.

Data presented in FIGS. 30 and 31 can be used to identify a relationship between maximum void size and density of the elevated portions. Referring to FIG. 30, using a base design condition and considering features of differing feature lengths provides an empirical relationship for largest void size versus feature length. This relationship can scale to differing elevated feature densities by magnification or demagnification of the design. In particular, the size of the voids will scale as 1/\sqrt{N_{DEP}}, where N_{DEP} is the number density of the features. This approach was used to generate FIG. 31 from the empirical data shown in FIG. 30. FIG. 31 shows void size scaled to feature number densities based on a diameter of 0.5 mm, at 2447/cm² feature density.

One can also fit a suitable equation to the data points in FIG. 30, and then apply a 1/\sqrt{N_{DEP}} scaling factor to create an equation that estimates void size versus density and length of the elevated portions. Using this approach, an equation of exponential form that is equal to 1.0 at a density of 2447 features/cm² at a feature length of 0.2837 mm which is the base condition was developed. The exponential form is a reasonable choice for a fitting equation as it is known a priori that void diameters will tend toward zero for large feature lengths, and for small feature lengths, the void sizes will reach approach some maximum for a given feature density. The resulting equation is:

$${D}_{c} = 1.225 \sqrt{\frac{2447}{{N}_{DEP}}} {e}^{- 0.7159 L} {D}_{0}$$

In this formula N_{DEP} is the number density of the elevated portions (number of elevated portions per unit area) measured in cm⁻² and L is the average length of the elevated portions measured in mm. D_{c} is the estimated void diameter for the film based on a given reference diameter, D₀, at the base conditions—a design of 2447 features/cm² and a feature length of 0.2837 mm. The void diameter, D_{c}, of the light directing film is the diameter of a largest circle that can be overlaid on the surface of the light directing film without including at least a portion of an elevated portion. According to various embodiments within, and with particular reference to the retrospective void-filling process, it was demonstrated that the void size could be reduced by the addition of a small number of additional elevated portions. For example, the retrospectively added elevated portions may comprise less than 20% or even less than 10% of the total number of elevated portions in the arrangement. In particular, methods based on retrospective void filling can be used to create layouts that have void sizes less than 0.336 mm in diameter for a design of 2447 features/cm² and a feature length of 0.2837 mm. In our example we showed designs with voids less than 0.25 mm in diameter without significantly increasing feature density and with the same feature lengths. Generally increasing feature lengths and increasing feature density reduces void size. For a given feature length and feature density, all designs with similar or larger feature density and similar or larger feature length will all have similar or smaller void sizes. Expected void sizes based on the retrospective void filling design method can be determined.

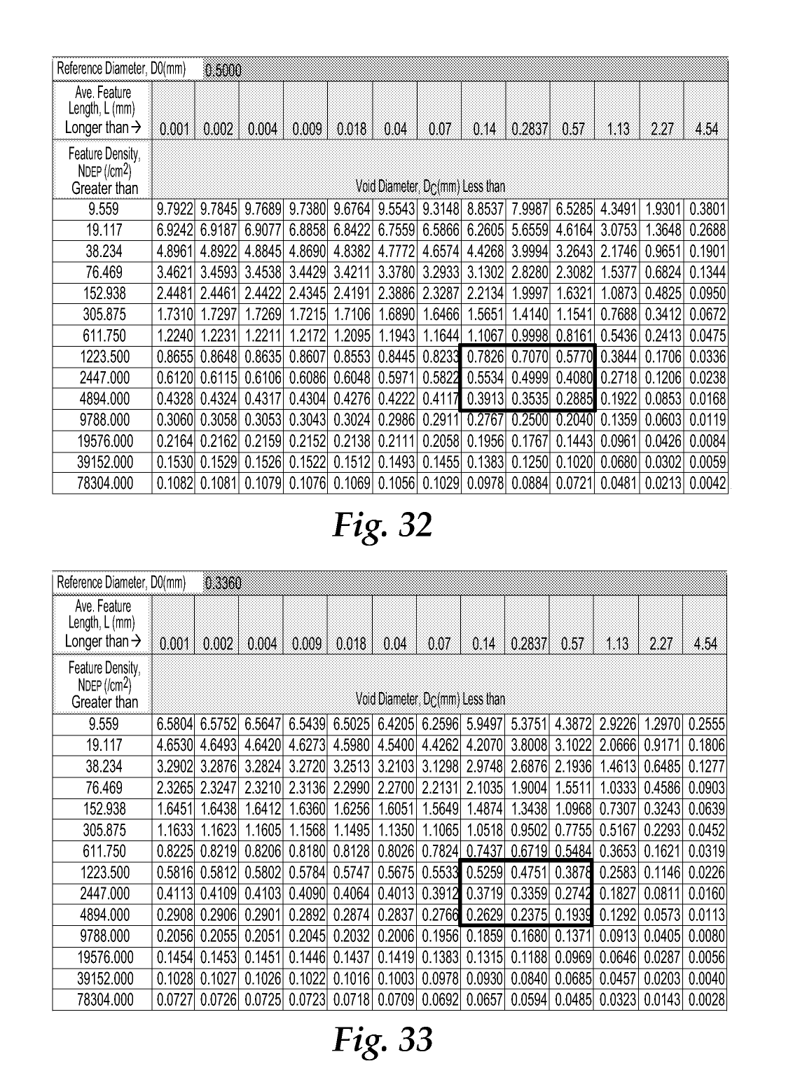

FIG. 32 provides a table that shows void sizes for various feature densities and lengths based on a reference void size at the base condition of 2447 features/cm² and 0.2837 mm feature length. The table of FIG. 32 provides void sizes for various feature densities and average feature lengths that can be achieved using retrospective void filling based on a reference void size, D₀, of 0.50 mm. The parameters for N_{DEP}, L and D_{c} can be achieved for films with a reference void size of 0.50 mm as in FIG. 32 can be achieved for films in which the light directing film cannot be divided into a plurality of same size and shape grid cells forming a continuous two-dimensional grid, where each of at least 90% of the grid cells comprise either a single leading edge of an elevated portion, or a portion of an elevated portion where the elevated portion has a length that is greater than the average length of the elevated portions. For example, as shown in the boxed area of the table of FIG. 32, this light directing film may have at least one of:

$$L \leq about 0.57 mm and {D}_{c} \leq [ \begin{matrix}about 0.577 mm , for {N}_{DEP} \leq about 1224 \text{/} {cm}^{2} \\ about 0.408 mm , for {N}_{DEP} \leq about 2448 \text{/} {cm}^{2} \\ about 0.289 mm , for {N}_{DEP} \leq about 4894 \text{/} {cm}^{2}\end{matrix} \\ L \leq about 0.28 mm and {D}_{c} \leq [ \begin{matrix}about 0.707 mm , for {N}_{DEP} \leq about 1224 \text{/} {cm}^{2} \\ about 0.5 mm , for {N}_{DEP} \leq about 2448 \text{/} {cm}^{2} \\ about 0.354 mm , for {N}_{DEP} \leq about 4894 \text{/} {cm}^{2}\end{matrix} ; \\ and \\ L \leq about 0.14 mm and {D}_{c} \leq [ \begin{matrix}about 0.783 mm , for {N}_{DEP} \leq about 1224 \text{/} {cm}^{2} \\ about 0.553 mm , for {N}_{DEP} \leq about 2448 \text{/} {cm}^{2} \\ about 0.391 mm , for {N}_{DEP} \leq about 4894 \text{/} {cm}^{2}\end{matrix}$$

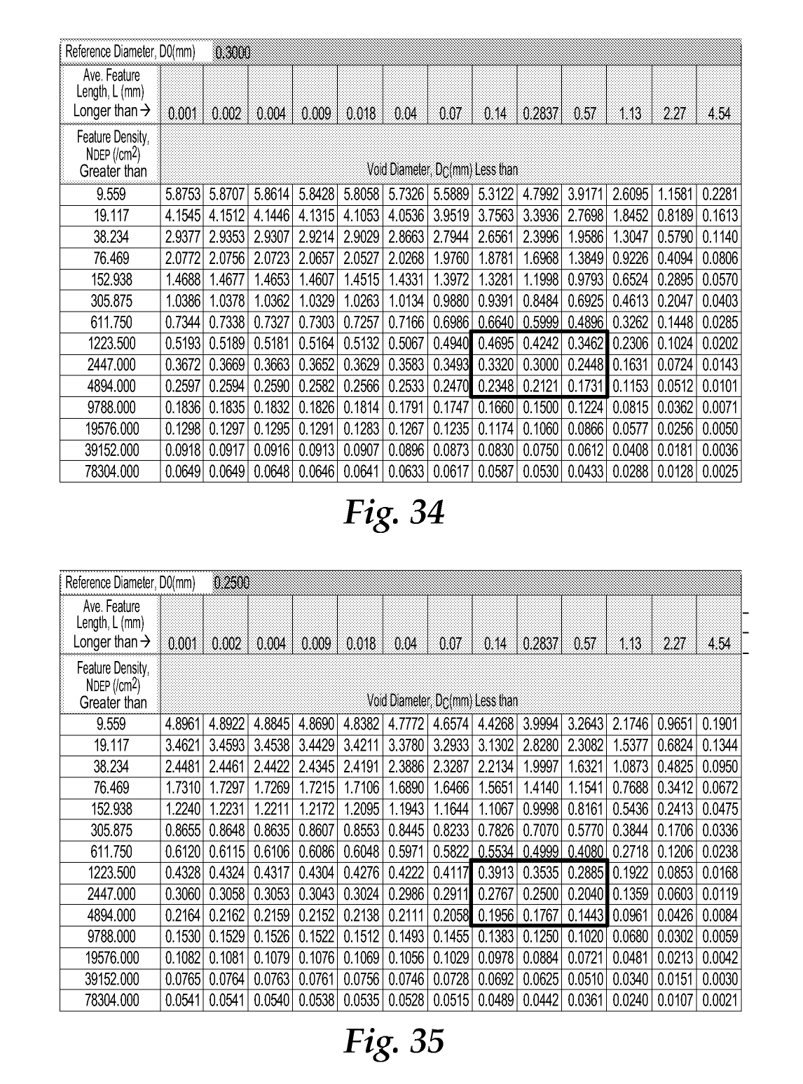

In some implementations, the values for the parameters for N_{DEP}, L and D_{c} shown in the tables of FIGS. 33-35 can be achieved for films using retrospective filling. The reference void size may be any suitable number, e.g., between about 0.336 mm and 0.25 mm, as illustrated in Tables 33-35. The table of FIG. 33 provides void sizes for various feature densities and lengths that can be achieved using retrospective void filling based on a reference void size of 0.336 mm; the table shown in FIG. 34 provides void sizes for various feature densities and lengths based on a reference void size of 0.30 mm; and the table shown in FIG. 35 provides void sizes for various feature densities and lengths based on a reference void size of 0.25 mm.

For example, a light directing film according to embodiments disclosed herein has a surface with a plurality of microstructures having peaks extending along a first direction. The surface includes an arrangement of elevated portions disposed in an irregular pattern on the peaks. The elevated portions have an average length, L, and a number density N_{DEP}, with voids between the elevated portions. Void size of the film is characterized by a circle having a maximum diameter, D_{c}, which is the diameter of a largest circle that can be overlaid on the surface of the light directing film without including at least a portion of an elevated portion.

In some implementations, as shown in the boxed area of the table of FIG. 33, the light directing film may have at least one of:

$$L \leq about 0.57 mm and {D}_{c} \leq [ \begin{matrix}about 0.387 mm , for {N}_{DEP} \leq about 1224 \text{/} {cm}^{2} \\ about 0.274 mm , for {N}_{DEP} \leq about 2448 \text{/} {cm}^{2} \\ about 0.193 mm , for {N}_{DEP} \leq about 4894 \text{/} {cm}^{2}\end{matrix} \\ L \leq about 0.28 mm and {D}_{c} \leq [ \begin{matrix}about 0.475 mm , for {N}_{DEP} \leq about 1224 \text{/} {cm}^{2} \\ about 0.335 mm , for {N}_{DEP} \leq about 2448 \text{/} {cm}^{2} \\ about 0.237 mm , for {N}_{DEP} \leq about 4894 \text{/} {cm}^{2}\end{matrix} ; \\ and \\ L \leq about 0.14 mm and {D}_{c} \leq [ \begin{matrix}about 0.525 mm , for {N}_{DEP} \leq about 1224 \text{/} {cm}^{2} \\ about 0.371 mm , for {N}_{DEP} \leq about 2448 \text{/} {cm}^{2} \\ about 0.262 mm , for {N}_{DEP} \leq about 4894 \text{/} {cm}^{2}\end{matrix}$$

In some implementations, as shown in the boxed area of the table of FIG. 34, the light directing film may have at least one of:

$$L \leq about 0.57 mm and {D}_{c} \leq [ \begin{matrix}about 0.346 mm , for {N}_{DEP} \leq about 1224 \text{/} {cm}^{2} \\ about 0.244 mm , for {N}_{DEP} \leq about 2448 \text{/} {cm}^{2} \\ about 0.173 mm , for {N}_{DEP} \leq about 4894 \text{/} {cm}^{2}\end{matrix} \\ L \leq about 0.28 mm and {D}_{c} \leq [ \begin{matrix}about 0.424 mm , for {N}_{DEP} \leq about 1224 \text{/} {cm}^{2} \\ about 0.300 mm , for {N}_{DEP} \leq about 2448 \text{/} {cm}^{2} \\ about 0.212 mm , for {N}_{DEP} \leq about 4894 \text{/} {cm}^{2}\end{matrix} ; \\ and \\ L \leq about 0.14 mm and {D}_{c} \leq [ \begin{matrix}about 0.469 mm , for {N}_{DEP} \leq about 1224 \text{/} {cm}^{2} \\ about 0.332 mm , for {N}_{DEP} \leq about 2448 \text{/} {cm}^{2} \\ about 0.234 mm , for {N}_{DEP} \leq about 4894 \text{/} {cm}^{2}\end{matrix}$$

In some implementations, as shown in the boxed area of the table of FIG. 35, the light directing film may have at least one of:

$$L \leq about 0.57 mm and {D}_{c} \leq [ \begin{matrix}about 0.288 mm , for {N}_{DEP} \leq about 1224 \text{/} {cm}^{2} \\ about 0.204 mm , for {N}_{DEP} \leq about 2448 \text{/} {cm}^{2} \\ about 0.144 mm , for {N}_{DEP} \leq about 4894 \text{/} {cm}^{2}\end{matrix} \\ L \leq about 0.28 mm and {D}_{c} \leq [ \begin{matrix}about 0.353 mm , for {N}_{DEP} \leq about 1224 \text{/} {cm}^{2} \\ about 0.250 mm , for {N}_{DEP} \leq about 2448 \text{/} {cm}^{2} \\ about 0.176 mm , for {N}_{DEP} \leq about 4894 \text{/} {cm}^{2}\end{matrix} ; \\ and \\ L \leq about 0.14 mm and {D}_{c} \leq [ \begin{matrix}about 0.391 mm , for {N}_{DEP} \leq about 1224 \text{/} {cm}^{2} \\ about 0.276 mm , for {N}_{DEP} \leq about 2448 \text{/} {cm}^{2} \\ about 0.195 mm , for {N}_{DEP} \leq about 4894 \text{/} {cm}^{2}\end{matrix}$$

In various implementations, the void densities of FIGS. 32, 33, 34, and/or 35 can be achieved using grid-less or partially grid-based approaches. In some implementations, the light directing film cannot be divided into a plurality of same size and shape grid cells forming a continuous two-dimensional grid, where each of at least 90% of the grid cells comprise either a single leading edge of an elevated portion, or a portion of an elevated portion where the elevated portion has a length that is greater than the average length of the elevated portions. In some embodiments, the light directing film cannot be divided into a plurality of same size and shape grid cells forming a continuous two-dimensional grid, where each of at least 80%, 70%, 60%, or even 50% of the grid cells comprise either a single leading edge of an elevated portion, or a portion of an elevated portion where the elevated portion has a length that is greater than the average length of the elevated portions.

The layout methods discussed here allow the design feature arrangements with voids that are smaller than about 0.5 mm, or smaller than about 0.4 mm, or smaller than about 0.35 mm, or smaller than about 0.30 mm, or even smaller than about 0.25 mm based on modeling results for a 2447 features/cm² number density using a feature length of 0. 0.2837 mm. Comparable linear and random designs had large voids on the order of 0.53 mm in diameter. FIG. 31 shows the effect of scaling number density for a 0.5 mm void diameter and the 2447 features/cm² feature arrangement design reference. This nominal value assumes that feature length is scaled similarly inversely with the square root of void density. Also included on the plot are change cases that show the effect of changing feature length in factors of 2 using the approximate scaling factors shown in FIG. 29.

The following are exemplary embodiments according to the present disclosure:
Item 1. A light directing film comprising:

a surface comprising a plurality of microstructures with peaks extending along a length of the surface, each microstructure comprising a plurality of elevated portions and a plurality of non-elevated portions, wherein a diameter, D_{c}, of a largest circle that can be overlaid on the surface without including at least a portion of an elevated portion is less than about 0.5 mm, and wherein the light directing film cannot be divided into a plurality of same size and shape grid cells forming a continuous two-dimensional grid, where each of at least 90% of the grid cells comprise either a single leading edge of an elevated portion, or a portion of an elevated portion where the elevated portion has a length that is greater than the average length of the elevated portions.

Item 2. The light directing film of item 1, wherein a number density of the elevated portions in the arrangement, N_{DEP}, is less than or equal to about 2500/cm² and the average length, L, is less than about 0.3 mm.
Item 3. The light directing film of item 1, wherein a number density of the elevated portions in the arrangement, N_{DEP}, is less than or equal to about 1223/cm² and the average length, L, is less than about 0.6 mm.
Item 4. The light directing film of item 1, wherein D, is less than or equal to about 0.40 mm.
Item 5. The light directing film of item 1, wherein D, is less than or equal to about 0.30 mm.
Item 6. The light directing film of item 1, wherein a pitch of the microstructures is between about 5 microns to about 200 microns.
Item 7. The light directing film of item 1, wherein an average length, L, of the elevated portions is between about 0.15 and about 0.6 mm.
Item 8. The light directing film of item 1, wherein a lateral cross sectional area of a microstructure of the plurality of microstructures in a region of an elevated portion and a lateral cross sectional area of the microstructure in a region of a non-elevated portion have a same shape.
Item 9. A light directing film, comprising:

a surface comprising a plurality of microstructures having peaks extending along a length of the surface, the surface comprising an arrangement of elevated portions disposed in an irregular pattern on the peaks, wherein a void diameter, D_{c}, of a largest circle that can be overlaid on the surface of the light directing film without including at least a portion of an elevated portion is less than about

$$0.6125 \sqrt{\frac{2447}{{N}_{DEP}}} {e}^{- 0.7159 L} ,$$

where N_{DEP} is a number density of the elevated portions/cm², and L is an average length of the elevated portions in millimeters, and wherein the light directing film cannot be divided into a plurality of same size and shape grid cells forming a continuous two-dimensional grid, where each of at least 90% of the grid cells comprise either a single leading edge of an elevated portion, or a portion of an elevated portion where the elevated portion has a length that is greater than the average length of the elevated portions.
Item 10. The light directing film of item 9, wherein,

the light directing film has at least one of:

$$L \leq about 0.57 mm and {D}_{c} \leq [ \begin{matrix}about 0.577 mm , for {N}_{DEP} \leq about 1224 \text{/} {cm}^{2} \\ about 0.408 mm , for {N}_{DEP} \leq about 2448 \text{/} {cm}^{2} \\ about 0.289 mm , for {N}_{DEP} \leq about 4894 \text{/} {cm}^{2}\end{matrix} \\ L \leq about 0.28 mm and {D}_{c} \leq [ \begin{matrix}about 0.707 mm , for {N}_{DEP} \leq about 1224 \text{/} {cm}^{2} \\ about 0.5 mm , for {N}_{DEP} \leq about 2448 \text{/} {cm}^{2} \\ about 0.354 mm , for {N}_{DEP} \leq about 4894 \text{/} {cm}^{2}\end{matrix} ; \\ and \\ L \leq about 0.14 mm and {D}_{c} \leq [ \begin{matrix}about 0.783 mm , for {N}_{DEP} \leq about 1224 \text{/} {cm}^{2} \\ about 0.553 mm , for {N}_{DEP} \leq about 2448 \text{/} {cm}^{2} \\ about 0.391 mm , for {N}_{DEP} \leq about 4894 \text{/} {cm}^{2}\end{matrix} .$$

Item 11. The light directing film of item 9, wherein D₀ is about 0.5 mm and N_{DEP}, L, and D_{c} satisfy Table 32.
Item 12. A light directing film, comprising:

a surface comprising a plurality of microstructures having peaks extending along a length of the surface, the surface comprising an arrangement of elevated portions and non-elevated portions disposed in an irregular pattern on the peaks, wherein, L is an average length of the elevated portions, N_{DEP} is a number density of the elevated portions, and a void diameter, D_{c}, of the light directing film is a largest circle that can be overlaid on the surface of the light directing film without including at least a portion of an elevated portion, wherein the light directing film has at least one of:

$$L \leq about 0.57 mm and {D}_{c} \leq [ \begin{matrix}about 0.387 mm , for {N}_{DEP} \leq about 1224 \text{/} {cm}^{2} \\ about 0.274 mm , for {N}_{DEP} \leq about 2448 \text{/} {cm}^{2} \\ about 0.193 mm , for {N}_{DEP} \leq about 4894 \text{/} {cm}^{2}\end{matrix} \\ L \leq about 0.28 mm and {D}_{c} \leq [ \begin{matrix}about 0.475 mm , for {N}_{DEP} \leq about 1224 \text{/} {cm}^{2} \\ about 0.335 mm , for {N}_{DEP} \leq about 2448 \text{/} {cm}^{2} \\ about 0.237 mm , for {N}_{DEP} \leq about 4894 \text{/} {cm}^{2}\end{matrix} ; \\ and \\ L \leq about 0.14 mm and {D}_{c} \leq [ \begin{matrix}about 0.525 mm , for {N}_{DEP} \leq about 1224 \text{/} {cm}^{2} \\ about 0.371 mm , for {N}_{DEP} \leq about 2448 \text{/} {cm}^{2} \\ about 0.262 mm , for {N}_{DEP} \leq about 4894 \text{/} {cm}^{2}\end{matrix} .$$

Item 13. The light directing film of item 12, wherein the light directing film has one of:

$$L \leq about 0.57 mm and {D}_{c} \leq [ \begin{matrix}about 0.346 mm , for {N}_{DEP} \leq about 1224 \text{/} {cm}^{2} \\ about 0.244 mm , for {N}_{DEP} \leq about 2448 \text{/} {cm}^{2} \\ about 0.173 mm , for {N}_{DEP} \leq about 4894 \text{/} {cm}^{2}\end{matrix} \\ L \leq about 0.28 mm and {D}_{c} \leq [ \begin{matrix}about 0.424 mm , for {N}_{DEP} \leq about 1224 \text{/} {cm}^{2} \\ about 0.300 mm , for {N}_{DEP} \leq about 2448 \text{/} {cm}^{2} \\ about 0.212 mm , for {N}_{DEP} \leq about 4894 \text{/} {cm}^{2}\end{matrix} ; \\ and \\ L \leq about 0.14 mm and {D}_{c} \leq [ \begin{matrix}about 0.469 mm , for {N}_{DEP} \leq about 1224 \text{/} {cm}^{2} \\ about 0.332 mm , for {N}_{DEP} \leq about 2448 \text{/} {cm}^{2} \\ about 0.234 mm , for {N}_{DEP} \leq about 4894 \text{/} {cm}^{2}\end{matrix} .$$

Item 14. The light directing film of item 12, wherein the light directing film has one of:

$$L \leq about 0.57 mm and {D}_{c} \leq [ \begin{matrix}about 0.288 mm , for {N}_{DEP} \leq about 1224 \text{/} {cm}^{2} \\ about 0.204 mm , for {N}_{DEP} \leq about 2448 \text{/} {cm}^{2} \\ about 0.144 mm , for {N}_{DEP} \leq about 4894 \text{/} {cm}^{2}\end{matrix} \\ L \leq about 0.28 mm and {D}_{c} \leq [ \begin{matrix}about 0.353 mm , for {N}_{DEP} \leq about 1224 \text{/} {cm}^{2} \\ about 0.250 mm , for {N}_{DEP} \leq about 2448 \text{/} {cm}^{2} \\ about 0.176 mm , for {N}_{DEP} \leq about 4894 \text{/} {cm}^{2}\end{matrix} ; \\ and \\ L \leq about 0.14 mm and {D}_{c} \leq [ \begin{matrix}about 0.391 mm , for {N}_{DEP} \leq about 1224 \text{/} {cm}^{2} \\ about 0.276 mm , for {N}_{DEP} \leq about 2448 \text{/} {cm}^{2} \\ about 0.195 mm , for {N}_{DEP} \leq about 4894 \text{/} {cm}^{2}\end{matrix} .$$

Item 15. The light directing film of item 12, wherein a pitch of the microstructures is about 5 microns to about 200 microns.
Item 16. The light directing film of item 12, wherein a lateral cross sectional area of a microstructure of the plurality of microstructures in a region of an elevated portion and a lateral cross sectional area of the microstructure in a region of a non-elevated portion have a same shape.
Item 17. The light directing film of item 12, wherein heights of the elevated portions vary.
Item 18. The light directing film of item 12, wherein heights of the elevated portions are the same.
Item 19. The light directing film of item 12, wherein at least some of the microstructures comprise linear prisms.
Item 20. The light directing film of item 19, wherein an included angle of the linear prisms is about 80 degrees to about 110 degrees.
Item 21. A light directing film, comprising:

a surface having a plurality of microstructures with peaks extending along a length of the surface, the surface including an arrangement of elevated portions disposed on the peaks, wherein the arrangement of elevated portions is based on a quasi-random pattern.

Item 22. The light directing film of item 21, wherein the quasi-random pattern comprises one or more of:

a Sobel pattern;

a Halton pattern;

a reverse Halton pattern; and

a Neiderreiter pattern.

Item 23. A method of making a light directing film having a plurality of microstructures with peaks extending along a surface of the light directing film, the method comprising:

determining an arrangement for elevated portions disposed on the microstructures by obtaining two dimensional coordinates for the elevated portions using a quasi-random number generator; and

forming the microstructures with the elevated portions according to the arrangement.

Item 24. The method of item 23, wherein determining the arrangement further comprises modifying the coordinates to adjusted coordinates corresponding to locations on the peaks of the microstructures.
Item 25. The method of item 23, wherein obtaining the coordinates comprises obtaining the coordinates using at least one of a Sobel, a Halton, a reverse Halton, and a Neiderreiter algorithm.
Item 26. A method of making a light directing film having a plurality of microstructures with peaks extending along a length of a surface of the light directing film, the method comprising:

determining an arrangement for disposing elevated portions on the peaks, comprising:
obtaining one or more two dimensional coordinates;
comparing the coordinates with a criterion for placing the elevated portions, the criterion comprising a requirement for a minimum distance between the elevated portions;
selecting coordinates of the one or more coordinates that meet the criterion and rejecting coordinates of the one or more coordinates that fail to meet the criterion; and
determining positions of the elevated portions in the arrangement using the selected coordinates; and

forming the microstructures with the elevated portions according to the arrangement.

Item 27. The method of item 26, wherein the criterion takes into account anisotropy in shapes of the elevated portions.
Item 28. The method of item 26, wherein the minimum distance is about 1.3 mm.
Item 29. The method of item 26, wherein the minimum distance is about 1.9 mm.
Item 30. The method of item 26, wherein:

obtaining the one or more coordinates comprises obtaining K coordinates, where K is greater than or equal to two; and

if all the K coordinates are rejected for failure to meet the criterion, selecting a coordinate of the K coordinates that is a farthest distance from the elevated portions.

Item 31. The method of item 26, wherein:

obtaining the one or more coordinates comprises obtaining K coordinates, where K is greater than or equal to two; and

selecting the coordinates that meet the criterion and rejecting the coordinates that fail to meet the criterion comprises selecting at least one coordinate of the K coordinates that has a greater minimum distance than others of the K coordinates.

Item 32. A method of making a light directing film having a plurality of microstructures with peaks extending along a length of a surface of the light directing film, the method comprising:

determining an arrangement for disposing elevated portions on the peaks, comprising:
determining an initial arrangement using a first placement process to determine locations of a first fraction of the elevated portions; and
determining a final arrangement using a second placement process, different from the first placement process, to determine locations of a second fraction of the elevated portions; and

forming the microstructures with the elevated portions positioned according to the final arrangement.

Item 33. The method of item 32, wherein determining the final arrangement comprises:

identifying voids that exceed a maximum void diameter criterion in the initial arrangement; and placing the second fraction of the elevated portions at coordinates within the identified voids.

Item 34. The method of item 32, wherein:

determining the initial arrangement comprises:
obtaining a plurality of two dimensional coordinates for the elevated portions;
comparing coordinates of the plurality of coordinates with a minimum distance criterion between elevated portions;
using coordinates of the plurality of coordinates that meet the criterion in the arrangement and rejecting coordinates of the plurality of co that fail to meet the criterion; and

determining the final arrangement comprises:
identifying voids that exceed a maximum void diameter criterion in the initial arrangement; and
identifying positions for the second fraction of elevated portions at coordinates within the identified voids.
   Item 35. A light directing film, comprising:

a surface comprising a plurality of microstructures having peaks extending along a length of the surface, the surface comprising an arrangement of elevated portions and non-elevated portions disposed in an irregular pattern on the peaks, wherein a void diameter, D_{c}, of a largest circle that can be overlaid on the surface of the light directing film without including at least a portion of an elevated portion is less than about

$$1.225 \sqrt{\frac{2447}{{N}_{DEP}}} {e}^{- 0.7159 L} {D}_{0} ,$$

for D₀ between about 0.250 and 0.336 mm, where N_{DEP} is a number density of the elevated portions/cm², and L is an average length of the elevated portions in millimeters.
Item 36. The light directing film of item 35, wherein D₀ is about 0.336 mm and N_{DEP}, L, and D_{c} satisfy Table 33.
Item 37. The light directing film of item 35, wherein D₀ is about 0.30 mm and N_{DEP}, L, and D_{c} satisfy Table 34.
Item 38. The light directing film of item 35, wherein D₀ is about 0.25 mm and N_{DEP}, L, and D_{c} satisfy Table 35.

All patents, patent applications, and other publications cited above are incorporated by reference into this document as if reproduced in full. While specific examples are described in detail above to facilitate explanation of various embodiments, it should be understood that the intention is not to limit the possible embodiments to the specifics of these examples.

What is claimed is:

1. A light directing film comprising:
a surface comprising a plurality of microstructures with peaks extending along a length of the surface, each microstructure comprising a plurality of elevated portions and a plurality of non-elevated portions, wherein a diameter, D_{c}, of a largest circle that can be overlaid on the surface without including at least a portion of an elevated portion is less than about 0.5 mm, and wherein the light directing film cannot be divided into a plurality of same size and shape grid cells forming a continuous two-dimensional grid, where each of at least 90% of the grid cells comprise either a single leading edge of an elevated portion, or a portion of an elevated portion where the elevated portion has a length that is greater than the average length of the elevated portions.

2. The light directing film of claim 1, wherein a number density of the elevated portions in the arrangement, N_{DEP}, is less than or equal to about 2500/cm² and the average length, L, is less than about 0.3 mm.

3. The light directing film of claim 1, wherein a number density of the elevated portions in the arrangement, N_{DEP}, is less than or equal to about 1223/cm² and the average length, L, is less than about 0.6 mm.

4. The light directing film of claim 1, wherein a pitch of the microstructures is between about 5 microns to about 200 microns.

5. The light directing film of claim 1, wherein an average length, L, of the elevated portions is between about 0.15 and about 0.6 mm.

6. The light directing film of claim 1, wherein a lateral cross sectional area of a microstructure of the plurality of microstructures in a region of an elevated portion and a lateral cross sectional area of the microstructure in a region of a non-elevated portion have a same shape.

7. A light directing film, comprising:
a surface comprising a plurality of microstructures having peaks extending along a length of the surface, the surface comprising an arrangement of elevated portions disposed in an irregular pattern on the peaks, wherein a void diameter, D_{c}, of a largest circle that can be overlaid on the surface of the light directing film without including at least a portion of an elevated portion is less than about
$$0.6125 \sqrt{\frac{2447}{{N}_{DEP}}} {e}^{- 0.7159 L} ,$$
where N_{DEP} is a number density of the elevated portions/cm², and L is an average length of the elevated portions in millimeters, and wherein the light directing film cannot be divided into a plurality of same size and shape grid cells forming a continuous two-dimensional grid, where each of at least 90% of the grid cells comprise either a single leading edge of an elevated portion, or a portion of an elevated portion where the elevated portion has a length that is greater than the average length of the elevated portions.

8. A light directing film, comprising:
a surface having a plurality of microstructures with peaks extending along a length of the surface, the surface including an arrangement of elevated portions disposed on the peaks, wherein the arrangement of elevated portions is based on a quasi-random pattern.

9. The light directing film of claim 8, wherein the quasi-random pattern comprises one or more of:
a Sobel pattern;
a Halton pattern;
a reverse Halton pattern; and
a Neiderreiter pattern.

10. A light directing film, comprising:
a surface comprising a plurality of microstructures having peaks extending along a length of the surface, the surface comprising an arrangement of elevated portions and non-elevated portions disposed in an irregular pattern on the peaks, wherein a void diameter, D_{c}, of a largest circle that can be overlaid on the surface of the light directing film without including at least a portion of an elevated portion is less than about
$$1.225 \sqrt{\frac{2447}{{N}_{DEP}}} {e}^{- 0.7159 L} {D}_{0} ,$$
for D₀ between about 0.250 and 0.336 mm, where N_{DEP} is a number density of the elevated portions/cm², and L is an average length of the elevated portions in millimeters.
